(19) United States
(12) Patent Application Publication
(10) Pub. No.: US 2026/0158493 A1
(43) Pub. Date: Jun. 11, 2026

(54) SURFACE-PATTERNED, OMNIPHOBIC TILES (SPOTS), FABRICATION, LOADING, AND USE THEREOF

(71) Applicant: Cornell University, Ithaca, NY (US)

(72) Inventors: Nathaniel James Cira, Ithaca, NY (US); Shenghao Tan, Ithaca, NY (US); Samira Shiri, Salt Lake City, UT (US); Mohsin Jahan Qazi, Ithaca, NY (US); Jon Albo, Ithaca, NY (US); Arnold Chen, Ithaca, NY (US)

(21) Appl. No.: 18/711,776

(22) PCT Filed: Nov. 21, 2022
(86) PCT No.: PCT/US2022/050567

§ 371 Date: May 20, 2024

Related U.S. Application Data
(60) Provisional application No. 63/281,275, filed on Nov. 19, 2021.
(60) Provisional application No. 63/281,494, filed on Nov. 19, 2021.

(51) Int. Cl. B01L 3/00

(52) U.S. Cl. CPC B01L 3/5085; B01L 3/5088; B01L 2200/025; B01L 2300/161; B01L 2400/022

(57) ABSTRACT

This technology provides a liquid dispensing system with a liquid loading device that can be used to load small volumes of liquid by sliding over or under a surface-patterned substrate, or, alternately, moving the surface-patterned substrate over or under the liquid loading device. The surface-patterned substrate may be a substrate with patterned geometry or wettability. The liquid loading device spatially confines liquid against the surface-patterned substrate and delivers it to intended areas on the surface-patterned substrate. The liquid loading device accomplishes this by maintaining liquid in spatially confined sections, and moving relative to the substrate, by, for example, sliding over it to deposit liquid on the surface-patterned substrate. The liquid loading device utilizes geometry and/or wettability to achieve liquid confinement and delivery to intended areas on the surface-patterned substrate.

### CROSS-REFERENCE TO RELATED APPLICATIONS

This application claims the benefit of U.S. Provisional Ser. No. 63/281,275, filed Nov. 19, 2021 and entitled “Surface-Patterned, Omniphobic Tiles (Spots), Fabrication, Loading, And Use Thereof,” and U.S. Provisional Ser. No. 63/281,494, filed Nov. 19, 2021 and entitled “Surface-Patterned, Omniphobic Tiles (Spots), Fabrication, Loading, And Use Thereof.” The entire contents of the above-identified priority applications are hereby fully incorporated herein in their entirety by reference.

### TECHNICAL FIELD

This disclosure relates to a liquid dispensing system with a liquid loading device that can be used to load small volumes of liquid by sliding over or under a substrate, or, alternately, moving the substrate over or under the liquid loading device.

### BACKGROUND

The costs of sample and library preparation often limit the number of experiments that researchers perform and analyze by sequencing. The primary challenge for sample and library preparation is efficiently handling small liquid volumes of precious samples and expensive reagents. Most biological reactions are performed using manual or robotic pipetting to dispense and manipulate liquids in tubes or microtiter plates. Manual pipetting scales poorly in time and is difficult to execute reproducibly below 1 μL. Robotic liquid handling systems alleviate the requirement for manual labor but have large capital expenses, ongoing consumable costs, and, depending on the system, constraints on types and volumes of liquids. Both manual and robotic pipetting methods usually require a dedicated disposable pipette tip for each reagent added to each reaction. The consumable costs of pipette tips, expensive reagents, time required, and precious samples all limit the number of experiments that scientists can perform, which in turn limits the number of hypotheses that can be tested and overall scientific progress, especially in genomics where such experimentation is ubiquitous.

In recent years, these limitations have become even more pertinent in a few contexts: for addressing questions about complex systems with many potentially interacting components and many possible hypotheses; for the application of newer machine learning approaches that can provide powerful new insights, but require very large datasets; and for fully utilizing the massive parallel measurement capability of modern readout technologies, such as, for example, next generation sequencing (“NGS”) and high resolution imaging.

These limitations have provided motivation for the development of microfluidic liquid handling technologies involving emulsions, robotics, acoustofluidics, piezoelectrics, and ink-jet technologies. However, despite these development efforts, existing microfluidic solutions have failed to provide a general liquid handling platform with the experimental flexibility and intuitive ease of use required to change the current pipette/plate paradigm in biology.

An alternate technology is droplet arrays. Existing droplet arrays rely on patterning surfaces with hydrophilic regions separated by hydrophobic barriers to create unique sites for reactions, analogous to wells in microtiter plates, except where liquid droplets are separated by surface energy barriers rather than the plastic dividing walls of standard plates. While suitable for handling water and a small set of highly polar liquids, existing droplet arrays fail with the addition of components that lower the liquid surface tension, such as, for example, lysis reagents, polymerase chain reaction (“PCR”) reagents, certain types and concentrations of proteins, ethanol, and numerous additional components that lower liquid surface tension. These lower surface energy components are necessary for most biological and genomic reactions, and the inability to handle the lower surface energy components has severely limited the broad use of existing droplet arrays for genomics and biology.

### SUMMARY

Described in certain example embodiments here are systems comprising: a loading device; and a substrate, the loading device configured to deposit one or more liquid(s) on the substrate and to confine the one or more liquid(s) within the loading device, the loading device comprising: a liquid confinement area comprising at least one opening in a bottom layer of the loading device configured to hold the one or more liquid(s) and to transfer the one or more liquid(s) to the substrate, and a calibration mechanism that provides calibration of movement relative to the substrate; and the substrate comprising: a plurality of a first region having a first contact angle with the one or more liquid(s) in the loading device, and one or more second region(s) located to surround the plurality of the first region and having a second contact angle with the one or more liquid(s) in the loading device, wherein the system is configured to transfer the one or more liquid(s) from the loading device to one or more of the pluralit(ies) of the first region of the substrate.

In certain example embodiments, the system is configured to control a volume of the one or more liquid(s) transferred to each of the one or more of the pluralit(ies) of the first region of the substrate.

In certain example embodiments, the loading device is configured to move across a top surface of the substrate to transfer the one or more liquid(s) from the loading device to one or more of the pluralit(ies) of the first region of the substrate.

In certain example embodiments, the calibration mechanism is configured to adjust a path of the movement of the loading device.

In certain example embodiments, the at least one opening comprising a position above one or more of the pluralit(ies) of the first region of the substrate.

In certain example embodiments, the movement comprising one or more direction(s).

In certain example embodiments, the system comprises a frame to constrain the orientation of the loading device relative to the substrate in at least one direction.

In certain example embodiments, the system comprises a gap between the bottom layer of the loading device and the substrate.

In certain example embodiments, the gap comprising a distance between the bottom layer of the loading device and the substrate less than the capillary length of the one or more liquids.

In certain example embodiments, the gap comprising a substantially uniform distance between the bottom layer of the loading device and the substrate.

In certain example embodiments, the gap comprising a non-uniform distance between the bottom layer of the loading device and the substrate.

In certain example embodiments, the system comprises spacer elements affixable to the loading device or the substrate to form the gap.

In certain example embodiments, the system comprises an external structure or surface to form the gap.

In certain example embodiments, the liquid confinement area comprising an elongated configuration.

In certain example embodiments, the liquid confinement area comprising one or more confinement section(s).

In certain example embodiments, the at least one opening comprising a rectangular, square, circular, trapezoidal, oval, or polygonal cross section.

In certain example embodiments, the loading device further comprising one or more geometrical pinning structure(s) one the bottom layer of the loading device configured to confine the one or more liquid(s) and to transfer the one or more liquid(s) to the substrate.

In certain example embodiments, wherein one or more surface(s) of the one or more geometrical pinning structure(s) comprise a coating.

In certain example embodiments, the coating of the one or more surface(s) comprising a hydrophobic, omniphobic, oleophobic, superhydrophobic, superomniphobic, or superoleophobic coating.

In certain example embodiments, the loading device comprising a coating on a face of the loading device proximal to the substrate, the coating spatially confining the one or more liquid(s) within the loading device.

In certain example embodiments, the coating of the face of the loading device comprising a hydrophobic, omniphobic, oleophobic, superhydrophobic, superomniphobic, or superoleophobic coating.

In certain example embodiments, the calibration mechanism comprising a polymer, glass, metal, wood, or any combination thereof.

In certain example embodiments, further comprising a liquid holding element, the liquid holding element comprising at least one opening in a bottom layer of the liquid holding element and configured to hold the one or more liquid(s) and to transfer the one or more liquid(s) to the substrate.

In certain example embodiments, the liquid holding element comprising a rectangular, square, circle, trapezoidal, or polygonal cross section.

In certain example embodiments, the liquid holding element comprising a coating on a face of the liquid holding element proximal to the substrate, the coating spatially confining the one or more liquid(s) within the liquid holding element.

In certain example embodiments, the coating comprising a hydrophobic, omniphobic, oleophobic, superhydrophobic, superomniphobic, or superoleophobic coating.

In certain example embodiments, the liquid holding element comprising one or more interchangeable distribution block(s), the one or more interchangeable distribution block(s) arranged to provide at the at least one opening in the bottom layer of the liquid holding element.

In certain example embodiments, each block of the one or more interchangeable distribution block(s) comprising zero or more openings to hold the one or more liquid(s).

In certain example embodiments, the liquid holding element comprising a polymer, glass, metal, or any combination thereof.

In certain example embodiments, the calibration mechanism comprising a housing configured to secure the liquid holding element in the loading device.

In certain example embodiments, the housing comprising two or more symmetrical structures to mate with two or more grooves on the liquid holding element.

In certain example embodiments, the housing comprising two or more grooves to mate with two or more symmetrical structures on the liquid holding element.

In certain example embodiments, the one or more liquid(s) being spatially confined by a coating on a face of the loading device proximal to the substrate.

In certain example embodiments, the coating comprising a hydrophobic, omniphobic, oleophobic, superhydrophobic, superomniphobic, or superoleophobic coating.

In certain example embodiments, the one or more liquid(s) are confined in through-holes.

In certain example embodiments, the through-holes are straight.

In certain example embodiments, the through-holes are tapered.

In certain example embodiments, walls of the through-holes comprise a coating such that the one or more liquid(s) move freely through the through-holes.

In certain example embodiments, the coating comprising a hydrophobic, omniphobic, oleophobic, superhydrophobic, superomniphobic, or superoleophobic coating.

In certain example embodiments, the coating comprising a low sliding angle.

In certain example embodiments, the one or more liquid(s) are confined in indentations.

In certain example embodiments, the indentations comprising a coating such that the one or more liquid(s) move freely through the indentations.

In certain example embodiments, the coating comprising a hydrophobic, omniphobic, oleophobic, superhydrophobic, superomniphobic, or superoleophobic coating.

In certain example embodiments, the coating comprising a low sliding angle.

In certain example embodiments, wherein the one or more liquid(s) are confined on a substantially planar surface.

In certain example embodiments, the loading device comprising a metal, glass, ceramic, or polymer.

In certain example embodiments, the loading device manufactured by 3D printing, milling, molding, thermoforming, machining, cutting, punching, forming, shearing, stamping, or lithographically printing.

In certain example embodiments, the plurality of the first region and the one or more second region(s) are in a same plane as a top surface of the substrate.

In certain example embodiments, the one or more second region(s) are in a same plane as a top surface of the substrate and the plurality of the first region are disposed in a lower position relative to the one or more second region(s).

In certain example embodiments, the plurality of the first region are wells with a depth of 0 to 3 mm relative to the top surface of the substrate.

In certain example embodiments, the plurality of the first region comprises a hydrophilic, oleophilic, or omniphilic coating.

In certain example embodiments, the plurality of the first region comprises a high surface energy coating.

In certain example embodiments, the one or more second region(s) comprise a hydrophobic, omniphobic, oleophobic, superhydrophobic, superomniphobic, or superoleophobic coating.

In certain example embodiments, the one or more second region(s) comprise a low surface energy coating.

In certain example embodiments, the first contact angle is less than or equal to 90°.

In certain example embodiments, the second contact angle is greater than or equal to 150°.

In certain example embodiments, the first contact angle of the first region is less than the second contact angle of the second region.

In certain example embodiments, the plurality of the first region comprises a shape of a circle, rectangle, square, trapezoid, oval, polygon, or any combination thereof.

Described in certain example embodiments herein is a loading device configured to deposit one or more liquid(s) on a substrate and to confine the one or more liquid(s) within the loading device, the loading device comprising: a liquid confinement area comprising at least one opening in a bottom layer of the loading device configured to hold the one or more liquid(s) and to transfer the one or more liquid(s) to the substrate; and a calibration mechanism that provides calibration of movement along the substrate, wherein the loading device is configured to transfer the one or more liquid(s) to the substrate.

In certain example embodiments, further comprising one or more geometrical pinning structure(s) one the bottom layer of the loading device configured to confine the one or more liquid(s) and to transfer the one or more liquid(s) to the substrate.

In certain example embodiments, one or more surface(s) of the one or more geometrical pinning structure(s) comprise a coating.

In certain example embodiments, the coating comprising a hydrophobic, omniphobic, oleophobic, superhydrophobic, superomniphobic, or superoleophobic coating.

In certain example embodiments, the liquid confinement area comprising an elongated configuration.

In certain example embodiments, the liquid confinement area comprising one or more confinement section(s).

In certain example embodiments, the at least one opening comprising a rectangular, square, circular, trapezoidal, oval, or polygonal cross section.

In certain example embodiments, the loading device comprising a coating on a face of the loading device proximal to the substrate, the coating spatially confining the one or more liquid(s) within the loading device.

In certain example embodiments, the coating comprising a hydrophobic, omniphobic, oleophobic, superhydrophobic, superomniphobic, or superoleophobic coating.

In certain example embodiments, the calibration mechanism comprising a polymer, glass, metal, wood, or any combination thereof.

In certain example embodiments, further comprising a liquid holding element, the liquid holding element comprising at least one opening in a bottom layer of the liquid holding element and configured to hold the one or more liquid(s) and to transfer the one or more liquid(s) to the substrate.

In certain example embodiments, the liquid holding element comprising a rectangular, square, circle, trapezoidal, or polygonal cross section.

In certain example embodiments, the liquid holding element comprising a coating on a face of the liquid holding element proximal to the substrate, the coating spatially confining the one or more liquid(s) within the liquid holding element.

In certain example embodiments, the coating comprising a hydrophobic, omniphobic, oleophobic, superhydrophobic, superomniphobic, or superoleophobic coating.

In certain example embodiments, the liquid holding element comprising one or more interchangeable distribution block(s), the one or more interchangeable distribution block(s) arranged to provide at the at least one opening in the bottom layer of the liquid holding element.

In certain example embodiments, each block of the one or more interchangeable distribution block(s) comprising zero or more openings to hold the one or more liquid(s).

In certain example embodiments, the liquid holding element comprising a polymer, glass, metal, or any combination thereof.

In certain example embodiments, the calibration mechanism comprising a housing configured to secure the liquid holding element in the loading device.

In certain example embodiments, the housing comprising two or more symmetrical structures to mate with two or more grooves on the liquid holding element.

In certain example embodiments, the housing comprising two or more grooves to mate with two or more symmetrical structures on the liquid holding element.

In certain example embodiments, the one or more liquid(s) being spatially confined by a coating on a face of the loading device proximal to the substrate.

In certain example embodiments, the coating comprising a hydrophobic, omniphobic, oleophobic, superhydrophobic, superomniphobic, or superoleophobic coating.

In certain example embodiments, wherein the one or more liquid(s) are confined in through-holes.

In certain example embodiments, wherein the through-holes are straight.

In certain example embodiments, wherein the through-holes are tapered.

In certain example embodiments, wherein walls of the through-holes comprise a coating such that the one or more liquid(s) move freely through the through-holes.

In certain example embodiments, the coating comprising a hydrophobic, omniphobic, oleophobic, superhydrophobic, superomniphobic, or superoleophobic coating.

In certain example embodiments, the coating comprising a low sliding angle.

In certain example embodiments, where the one or more liquid(s) are confined in indentations.

In certain example embodiments, the indentations comprise a coating such that the one or more liquid(s) move freely through the through-holes.

In certain example embodiments, the coating comprising a hydrophobic, omniphobic, oleophobic, superhydrophobic, superomniphobic, or superoleophobic coating.

In certain example embodiments, the coating comprising a low sliding angle.

In certain example embodiments, wherein the one or more liquid(s) are confined on a substantially planar surface.

In certain example embodiments, the loading device comprising a metal, glass, ceramic, or polymer.

In certain example embodiments, the loading device manufactured by 3D printing, milling, molding, thermoforming, machining, cutting, punching, forming, shearing, stamping, or lithographically printing.

Described in certain example embodiments herein is a substrate, comprising: a plurality of a first region wherein the plurality of the first region has a first contact angle relative to one or more liquid(s) in a loading device; and one or more second region(s) located to surround the plurality of the first region and wherein the one or more second region(s) have a second contact angle relative to the one or more liquid(s) in the loading device, wherein the substrate is configured to receive the one or more liquid(s) from the loading device such that the one or more liquid(s) are confined to one or more of the pluralit(ies) of the first region of the substrate.

In certain example embodiments, the plurality of the first region and the one or more second region(s) are in a same plane as a top surface of the substrate.

In certain example embodiments, the one or more second region(s) are in a same plane as a top surface of the substrate and the plurality of the first region are disposed in a lower position relative to the one or more second region(s).

In certain example embodiments, the plurality of the first region are wells with a depth of 0 to 3 mm relative to the top surface of the substrate.

In certain example embodiments, the plurality of the first region comprises a hydrophilic, oleophilic, or omniphilic coating.

In certain example embodiments, the plurality of the first region comprises a high surface energy coating.

In certain example embodiments, the one or more second region(s) comprise a hydrophobic, omniphobic, oleophobic, superhydrophobic, superomniphobic, or superoleophobic coating.

In certain example embodiments, the one or more second region(s) comprise a low surface energy coating.

In certain example embodiments, the first contact angle is less than or equal to 90°.

In certain example embodiments, the second contact angle is greater than or equal to 150°.

In certain example embodiments, the plurality of the first region comprises a shape of a circle, rectangle, square, trapezoid, oval, polygon, or any combination thereof.

In certain example embodiments, the substrate configured to transfer one or more liquid(s) to a receiving vessel or set of receiving vessels.

In certain example embodiments, the receiving vessel or set of receiving vessels is a second substrate.

In certain example embodiments, the receiving vessel or set of receiving vessels comprises one or more wells.

In certain example embodiments, the substrate is configured to transfer the one or more liquid(s) to the receiving vessel or set of receiving vessels by acceleration or pressure.

In certain example embodiments, the substrate is configured to transfer liquid to the second substrate by direct contact between the one or more liquid(s) on the substrate and one or more liquid(s) on the second substrate.

In certain example embodiments, the substrate is configured to transfer liquid to the second substrate by direct contact between the one or more liquid(s) and the second substrate.

In certain example embodiments, the substrate is configured to receive one or more liquid(s) from a vessel or set of vessels.

In certain example embodiments, the vessel or set of vessels is a second substrate.

In certain example embodiments, the vessel or set of vessels comprises one or more wells.

In certain example embodiments, the substrate is configured to receive from the vessel or set of vessels by acceleration or pressure.

In certain example embodiments, the substrate is configured to receive liquid from the second substrate by direct contact between one or more liquid(s) on the second substrate and the one or more liquid(s).

Described in certain example embodiments herein is a method to deposit liquids on a substrate, the method comprising: positioning a loading device a distance above a substrate; inserting one or more liquid(s) into the loading device; and traversing the loading device at the distance above the substrate across the substrate in one or more directions.

Described in certain example embodiments herein is a system, comprising a loading device comprising at least one liquid reservoir, the at least one liquid reservoir defining an opening at a bottom portion of the at least one liquid reservoir to discharge a liquid borne by the at least one reservoir; a substrate holder, at least one of the loading device and/or the substrate holder being movably disposed relative to one another, the substrate holder comprising a substrate receiving area to removably receive a removable substrate, disposed adjacent to the loading device to dispose the substrate receiving area of the substrate holder adjacent the opening at the bottom portion of the at least one liquid reservoir over at least a portion of a range of movement of the loading device relative to the substrate holder; and one or more registration members provided on the loading device, the substrate holder, or both the loading device and the substrate holder to maintain a spacing between the opening at the bottom portion of the at least one liquid reservoir and an upper surface of a substrate borne within the substrate receiving at a predetermined spacing or within a range of predetermined spacings over at least a portion of a range of movement of the loading device relative to the substrate holder, wherein the predetermined spacing or and/or the range of predetermined spacings are selected to maintain a gap having a first height between a bottom surface of a droplet formed at the opening at the bottom portion of the at least one liquid reservoir and an upper surface of a substrate borne within the substrate over at least a portion of a range of movement of the loading device relative to the substrate holder.

In certain example embodiments, a height of the at least one liquid reservoir and an area of the opening defined at the bottom portion of the at least one liquid reservoir is dimensioned to form a droplet of a liquid borne by the at least one liquid reservoir having a first contact angle within a predetermined range of contact angles.

In certain example embodiments, the first height of the gap is less than a capillary length of a liquid borne by the at least one liquid reservoir.

In certain example embodiments, the loading device comprises a plurality of liquid reservoirs, each of the plurality of liquid reservoirs defining an opening at a bottom portion of the respective liquid reservoir to selectively discharge a liquid borne therein to a substrate borne by the substrate holder.

In certain example embodiments, the system further comprises a substrate dimensioned for removable placement within the substrate receiving area, the substrate comprising a first end at a first portion of the range of movement of the loading device relative to the substrate holder and the substrate borne therein and a second end at a second portion of the range of movement of the loading device relative to the substrate holder, the substrate further comprising at least one liquid confinement portion comprising a liquid receiving area in, on, or through the substrate.

In certain example embodiments, the substrate comprises a plurality of liquid confinement portions.

In certain example embodiments, the substrate comprises an array of the plurality of liquid confinement portions.

In certain example embodiments, the array of the plurality of liquid confinement portions comprises a n×m or a n×n array, wherein n or m can be any integer.

In certain example embodiments, the loading device and the substrate holder are movable relative to one another along one axis.

In certain example embodiments, the loading device and the substrate holder are translatable relative to one another.

In certain example embodiments, one of the loading device or the substrate holder is stationary and the other one of the loading device or the substrate holder is translatable relative to the other one of the loading device or the substrate holder.

In certain example embodiments, one of the loading device or the substrate holder is stationary and the other one of the loading device or the substrate holder is rotatable relative to the other one of the loading device or the substrate holder.

In certain example embodiments, the loading device and the substrate holder are movable relative to one another along a plurality of axes.

In certain example embodiments, the plurality of liquid reservoirs are disposed in an array across at least a portion of the loading device.

In certain example embodiments, the array of the plurality of liquid reservoirs comprises a n×m or a n×n array, wherein n or m can be any integer.

In certain example embodiments, an upper surface of the substrate outside the liquid receiving areas comprises a hydrophobic, omniphobic, oleophobic, superhydrophobic, superomniphobic, or superoleophobic coating.

In certain example embodiments, the liquid confinement portion(s) comprise a hydrophilic, oleophilic, or omniphilic coating.

In certain example embodiments, an upper surface of the substrate comprises a first coating and the liquid confinement portion(s) comprise a second coating different than the first coating.

These and other aspects, objects, features, and advantages of the example embodiments will become apparent to those having ordinary skill in the art upon consideration of the following detailed description of example embodiments.

### BRIEF DESCRIPTION OF THE DRAWINGS

FIG. 1 is a perspective view of an example liquid loading device.

FIG. 2A is a perspective view of a liquid holding element. FIG. 2B is a perspective view of a carrier. FIG. 2C is a perspective view of a combined assembly of the liquid holding element and the carrier.

FIGS. 3A and 3B are top perspective views of example liquid loading device opening(s) configurations. FIG. 3C is a top view of an example liquid loading device opening(s) configuration. FIGS. 3D, 3E, and 3F are bottom perspective views of example liquid holding element bottom opening(s) configurations.

FIG. 4A depicts example embodiments of interchangeable liquid distribution blocks. FIG. 4B is a bottom view of a liquid loading device comprising interchangeable liquid distribution blocks.

FIG. 5A is a top perspective view of an example small volume loader holding device. FIG. 5B is a cross-sectional front view of an example small volume loader assembly. FIG. 5C is a top perspective view of an example small volume loader device. FIGS. 5D and 5E are example cross-sectional side views of further examples of small volume loader devices.

FIG. 6A is a side view of an alternate embodiment of a carrier. FIG. 6B is a perspective view of the alternate embodiment of a carrier. FIG. 6C is a cross-sectional front view of an alternate embodiment of a carrier.

FIG. 7A is a top view of an example insertable gap control board. FIG. 7B is a top perspective view of an alternate embodiment of a carrier. FIG. 7C is a side perspective view of an assembly of an insertable gap control board and a carrier. FIG. 7D is a side perspective view of an assembly of an insertable gap control board, a carrier, and a small volume loader device.

FIG. 8A is a cross-sectional front view of an example insertable gap control board. FIG. 8B is a cross-sectional front view of an assembly of an insertable gap control board and a carrier. FIG. 8C is a cross-sectional front view of an assembly of an insertable gap control board, a carrier, and a small volume loader device. FIG. 8D is a front view of an insertable gap control board.

FIG. 9 is a perspective view of a surface-patterned substrate.

FIG. 10 is a perspective view of an example liquid dispensing system.

FIG. 11A is a top perspective view of an example embodiment of a liquid loading device. FIG. 11B is a top perspective view of an example embodiment of a liquid dispensing system. FIG. 11C is a side view of a liquid dispensing system. FIG. 11D is a front view of a liquid dispensing system.

FIGS. 12A and 12B are top views of example embodiments indicating example direction(s) of movement of components of a liquid dispensing system.

FIGS. 13A, 13B, 13C, 13D, and 13E are cross-sectional front views of liquid dispensing systems with example spacer elements.

FIG. 14A is a graphical depiction of example liquid volume distributions. FIGS. 14B and 14C are cross-sectional front views of example embodiments of liquid dispensing systems.

FIG. 15A is a front view of an example embodiment of a liquid dispensing system with an elongated through-hole dimensioned to confine liquid in the liquid loading device. FIG. 15B is a side view of a liquid dispensing system depicting an optional indentation for confining liquid in the liquid loading device. FIG. 15C is a is a side view of a liquid dispensing system depicting an indentation for confining liquid with liquid confined therein.

FIG. 16A is a front view of an example embodiment of a liquid dispensing system with multiple liquid loading device openings. FIG. 16B is a front view of an example embodiment of a liquid dispensing system with multiple liquid loading device openings comprising one or more liquid(s).

FIG. 17A is a side view of a liquid dispensing system comprising an example tapered through-hole for confining liquid in the liquid loading device. FIG. 17B is a side view of a liquid dispensing system comprising an example tapered through-hole for confining liquid in the liquid loading device with liquid.

FIGS. 18A, 18B, 18C, 18D, and 18E depict side views of example embodiments of liquid dispensing systems with varying geometrical liquid loading device to surface-patterned substrate interfaces.

FIG. 19 is a side view of an example embodiment of a liquid dispensing system depicting a geometrical configuration of liquid pinned beneath the liquid loading device and above the surface-patterned substrate.

FIG. 20A is a side front view of an example embodiment of a liquid dispensing system. FIG. 20B is a front view of an example liquid distribution pattern. FIG. 20C is a front view of another example liquid distribution pattern.

FIGS. 21A and 21B are top perspective views of example liquid distribution patterns for example liquid dispensing systems.

FIG. 22A is a top view of a liquid loading device confining and distributing multiple liquids on a surface-patterned substrate. FIG. 22B is a top view depicting two surface-patterned substrates with varying row and column distribution patterns along with the resulting combination after sandwiching the two leftmost plates.

FIGS. 23A and 23B depict an example application of a liquid dispensing system related to combinatorial materials.

FIGS. 24A and 24B depict an example application of a liquid dispensing system related to testing antibiotic combinations.

FIGS. 25A and 25B depict transfer of liquids from a set of wells to surface-patterned substrate and from surface-patterned substrate to a set of well.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only and is not intended to be limiting.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, ‘less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, ‘greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

### General Definitions

Unless defined otherwise, technical and scientific terms used herein have the same meaning as commonly understood by one of ordinary skill in the art to which this disclosure pertains. Definitions of common terms and techniques in molecular biology may be found in Molecular Cloning: A Laboratory Manual, 2^{nd} edition (1989) (Sambrook, Fritsch, and Maniatis); Molecular Cloning: A Laboratory Manual, 4^{th} edition (2012) (Green and Sambrook); Current Protocols in Molecular Biology (1987) (F.M. Ausubel et al. eds.); the series Methods in Enzymology (Academic Press, Inc.): PCR 2: A Practical Approach (1995) (M. J. MacPherson, B. D. Hames, and G. R. Taylor eds.): Antibodies, A Laboratory Manual (1988) (Harlow and Lane, eds.): Antibodies A Laboratory Manual, 2^{nd} edition 2013 (E.A. Greenfield ed.); Animal Cell Culture (1987) (R. I. Freshney, ed.); Benjamin Lewin, Genes IX, published by Jones and Bartlet, 2008 (ISBN 0763752223); Kendrew et al. (eds.), The Encyclopedia of Molecular Biology, published by Blackwell Science Ltd., 1994 (ISBN 0632021829); Robert A. Meyers (ed.), Molecular Biology and Biotechnology: a Comprehensive Desk Reference, published by VCH Publishers, Inc., 1995 (ISBN 9780471185710); Singleton et al., Dictionary of Microbiology and Molecular Biology 2^{nd} ed., J. Wiley & Sons (New York, N.Y. 1994), March, Advanced Organic Chemistry Reactions, Mechanisms and Structure 4^{th} ed., John Wiley & Sons (New York, N.Y. 1992); and Marten H. Hofker and Jan van Deursen, Transgenic Mouse Methods and Protocols, 2^{nd} edition (2011).

Definitions of common terms and techniques in chemistry and organic chemistry can be found in Smith. Organic Synthesis, published by Academic Press. 2016; Tinoco et al. Physical Chemistry, 5^{th} edition (2013) published by Pearson; Brown et al., Chemistry, The Central Science 14^{th} ed. (2017), published by Pearson, Clayden et al., Organic Chemistry, 2^{nd} ed. 2012, published by Oxford University Press; Carey and Sunberg, Advanced Organic Chemistry, Part A: Structure and Mechanisms, 5th ed. 2008, published by Springer; Carey and Sunberg, Advanced Organic Chemistry, Part B: Reactions and Synthesis, 5^{th} ed. 2010, published by Springer, and Vollhardt and Schore, Organic Chemistry, Structure and Function; 8^{th} ed. (2018) published by W. H. Freeman.

As used herein, the singular forms “a”, “an”, and “the” include both singular and plural referents unless the context clearly dictates otherwise.

As used herein, “about,” “approximately,” “substantially,” and the like, when used in connection with a measurable variable such as, for example, a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as, for example, variations of +/−10% or less, +/−5% or less, +/−1% or less, and +/−0.1% or less of and from the specified value, insofar such variations are appropriate to perform in the disclosed invention. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

The recitation of numerical ranges by endpoints includes all numbers and fractions subsumed within the respective ranges, as well as the recited endpoints.

As used herein, a “biological sample” refers to a sample obtained from, made by, secreted by, excreted by, or otherwise containing part of or from a biologic entity. A biologic sample can contain whole cells and/or live cells and/or cell debris, and/or cell products, and/or virus particles. The biological sample can contain (or be derived from) a “bodily fluid”. The biological sample can be obtained from an environment (e.g., water source, soil, air, and the like). Such samples are also referred to herein as environmental samples. As used herein “bodily fluid” refers to any non-solid excretion, secretion, or other fluid present in an organism and includes, without limitation unless otherwise specified or is apparent from the description herein, amniotic fluid, aqueous humor, vitreous humor, bile, blood or component thereof (e.g., plasma, serum, etc.), breast milk, cerebrospinal fluid, cerumen (earwax), chyle, chyme, endolymph, perilymph, exudates, feces, female ejaculate, gastric acid, gastric juice, lymph, mucus (including nasal drainage and phlegm), pericardial fluid, peritoneal fluid, pleural fluid, pus, rheum, saliva, sebum (skin oil), semen, sputum, synovial fluid, sweat, tears, urine, vaginal secretion, vomit and mixtures of one or more thereof. Biological samples include cell cultures, bodily fluids, cell cultures from bodily fluids. Bodily fluids may be obtained from an organism, for example by puncture, or other collecting or sampling procedures.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment,” “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some, but not other, features included in other embodiments, combinations of features of different embodiments are meant to be within the scope of the invention. For example, in the appended claims, any of the claimed embodiments can be used in any combination.

### Overview

In some examples, the present technology is directed to a liquid dispensing system and/or constituent parts and/or subsystems thereof, wherein the liquid dispensing system itself comprising a liquid loading device that can be used to load small volumes of liquid to a substrate by moving the liquid loading device relative to the substrate (e.g., moving the liquid loading device, moving the substrate, and/or moving both the liquid loading device and the substrate). The substrate may be a substrate with patterned geometry or wettability.

The liquid loading device spatially confines liquid against a substrate and selectively delivers it to intended areas on the substrate. The liquid loading device accomplishes this by maintaining liquid in spatially confined sections, and moving relative to the substrate, by, for example, sliding over it to selectively deposit liquid on the intended areas of the substrate. The liquid loading device utilizes geometry and/or wettability to achieve liquid confinement and delivery to the intended areas on the substrate.

In some examples, the liquid loading device laterally spans over a substrate. In some examples, the liquid loading device comprises one or more spacer element(s) to ensure a gap of a desired height is maintained between the substrate and the liquid loading device. For instance, in some examples, the liquid loading device comprises lips to maintain the relative position of the two elements to each other in one axis while allowing the liquid loading device to slide over the substrate in another axis. The liquid loading device contains a through-hole that acts as a liquid reservoir and permits liquid to contact the substrate for deposition. Alternately, indentations, a flat surface, or protrusions may be used instead of the through-hole.

In some examples, a coating such as, for example, a superhydrophobic or superomniphobic coating may be used on the surface of the liquid loading device proximal to the substrate to prevent liquid from spilling beyond intended confines. The walls of the through-hole may be coated (e.g., a hydrophobic, omniphobic, oleophobic, superhydrophobic, superomniphobic, or superoleophobic coating) such that the liquid maintains contact with the substrate as it is being deposited and does not adhere to or become stuck in the through-hole.

In some examples, the liquid loading device may have multiple areas, such as, for example, multiple reservoirs, capable of confining multiple liquid elements simultaneously to, for example, load different rows or columns on a substrate. The liquid loading device may have geometrical features that pin liquid from spreading beyond the intended confines, analogous to the angle presented in the Gibbs pinning criterion scenario. These geometrical features can be used alone, or in combination with coatings to enhance liquid repellency on the bottom of the liquid loading device.

In some examples, the substrate may be patterned with one or more regions (e.g., wells) to receive and retain a deposited fluid. In some examples, the substrate may be patterned with one or more region(s) that attract liquids and/or regions that repel liquids. In some examples, on the substrate the one or more regions to receive and retain a deposited fluid may comprise a coating to attract liquids and the balance of the substrate comprising regions having a coating to repel liquids. In some examples, to attract liquids, regions of the substrate where liquids deposits are desired may be coated with a hydrophilic, oleophilic, or omniphilic coating. As an example, the coating may be a silica coating, a metal coating, a metal oxide coating, or a hydrophilic, oleophilic, or omniphilic polymer coating. As the liquid loading device passes over the substrate, liquid(s) confined within the liquid loading device is/are attracted to the regions with the hydrophilic, oleophilic, or omniphilic coating. Similarly, regions of the substrate where liquid deposits are not desired may be coated with a hydrophobic, omniphobic, oleophobic, superhydrophobic, superomniphobic, or superoleophobic coating. As the liquid loading device passes over the substrate, liquids confined within the liquid loading device are repelled by the regions with the hydrophobic, omniphobic, oleophobic, superhydrophobic, superomniphobic, or superoleophobic coating. In other examples the substrate itself natively attracts the liquid sufficiently to provide a wettability mismatch between the regions that receive and retain a deposited fluid and a less wettable surrounding region with higher contact angle. In these examples the absence of a coating in the regions that receive and retain a deposited fluid provides the patterned wettability on the substrate.

These and other aspects, objects, features, and advantages of the disclosed technology will become apparent to those having ordinary skill in the art upon consideration of the following detailed description of illustrated examples.

### Example System Architecture

Turning now to the drawings, in which like numerals indicate like (but not necessarily identical) elements throughout the figures, examples of the technology are described in detail.

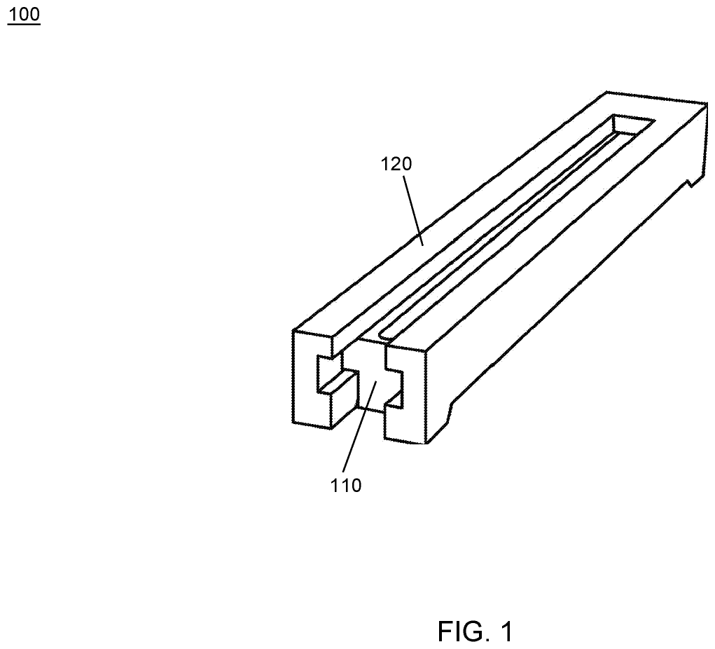

FIG. 1 is a perspective view of an example liquid loading device 100, in accordance with certain examples. In an example, liquid loading device 100 maintains one or more liquid(s) in one or more reservoirs(s) and, moving relative to a substrate, selectively deposits volumes of the one or more liquid(s) in designated regions of the substrate. In an example, the average volume depositions may be controlled to be in a range of 0.0001 microliter to 1 mL, including all 0.0001 microliter values and ranges therebetween, preferably less than 100 microliters, and optionally, the volume of the depositions has a substantially constant volume size. Optionally the coefficient of variation for a given volume is less than 200%, 100%, 80%, 60%, 50%, 40%, 30%, 20%, 10%, 5%, or 3% across loaded sites and across separate devices. The liquid loading device 100 utilizes geometry and/or wettability for liquid confinement and delivery to intended regions on the substrate. The liquid loading device 100 comprises liquid holding element 110 and carrier, or housing or frame, 120. In an example, the liquid loading device 100 is molded, cast, or otherwise formed as a solitary piece or unit comprising liquid holding element 110 and carrier 120. In an alternate example, liquid holding element 110 and carrier 120 are separate elements configured to be assembled to form liquid loading device 100. In an example, liquid loading device 100 is fabricated by 3D printing, milling, molding, thermoforming, machining (or other form of cutting), punching, forming, shearing, stamping, or lithography.

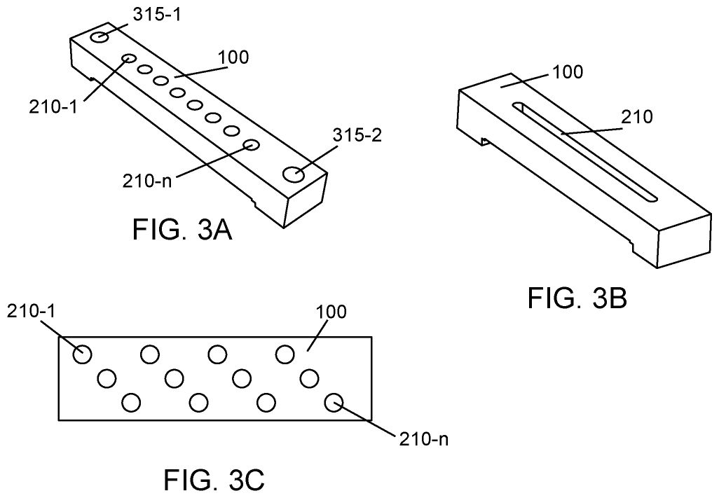

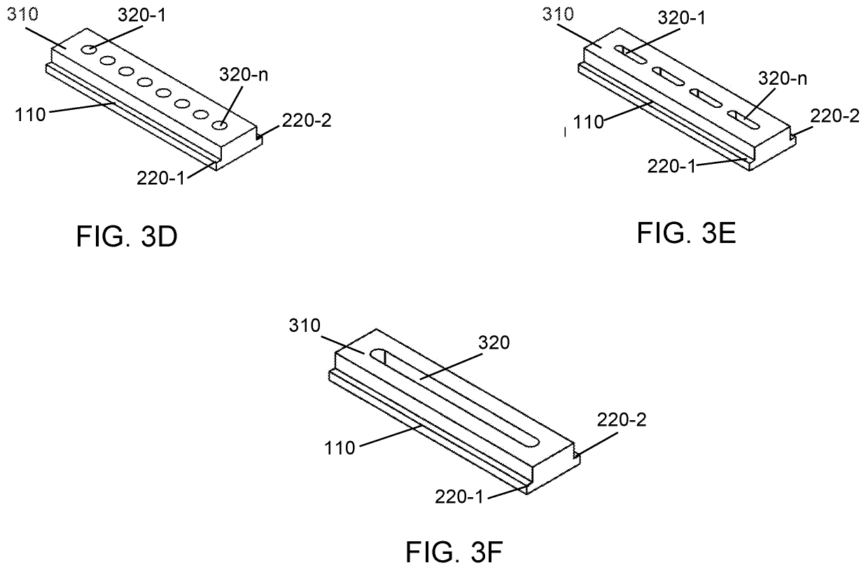

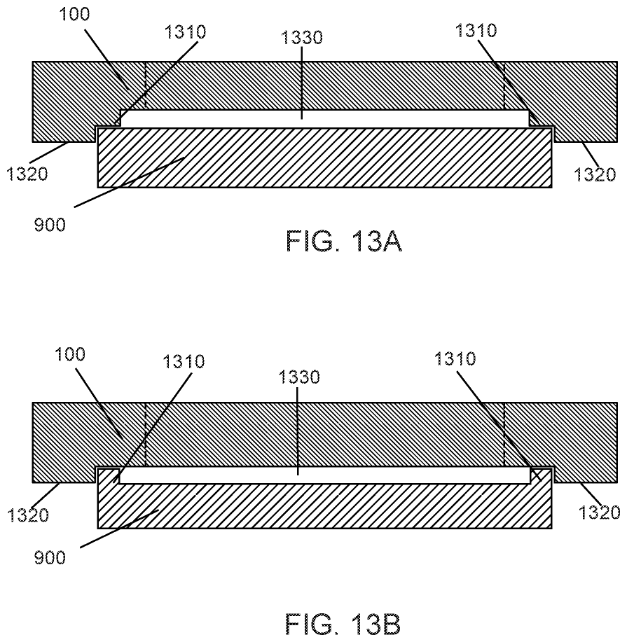

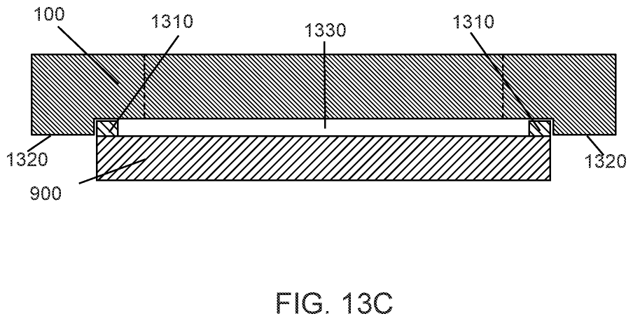

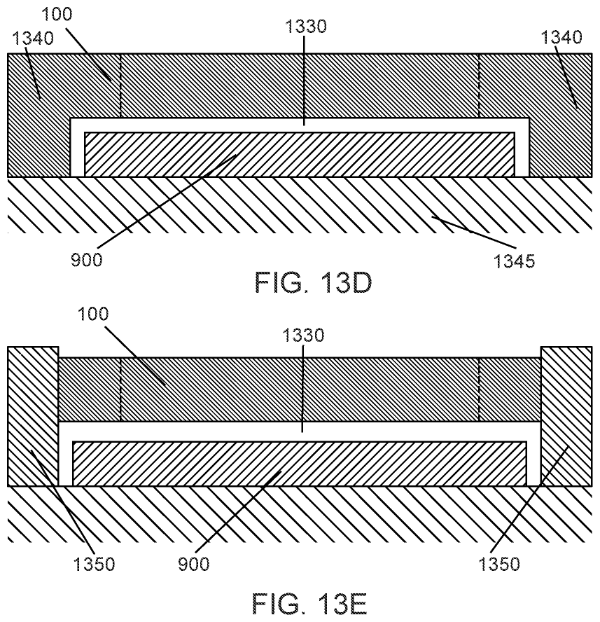

In an example embodiment, liquid loading device 100 may be milled out of a plastic such as, for example, a Polyoxymethylene (POM) (e.g., Delrin®). Liquid loading device 100 may include a spacer element and a lip, such as, for example, spacer element 1310 and lip 1320 depicted in FIGS. 13A-13C, such that liquid loading device 100 can slide across a substrate with a 400 micrometer spacing between the bottom of the liquid loading device 100 and the top of the substrate. One or more reservoirs are formed in the liquid loading device 100 to receive and retain the liquid to be loaded onto selected portions of the substrate. In some examples, the one or more reservoirs may comprise through hole(s) in the liquid loading device 100. In some examples, the liquid loading device 100 comprises a bottom surface, such as, for example, bottom surface 310 depicted in FIGS. 3D-3F, that is planar. In some examples, the reservoirs and/or the bottom surface of the liquid loading device 100 may comprise a functional coating.

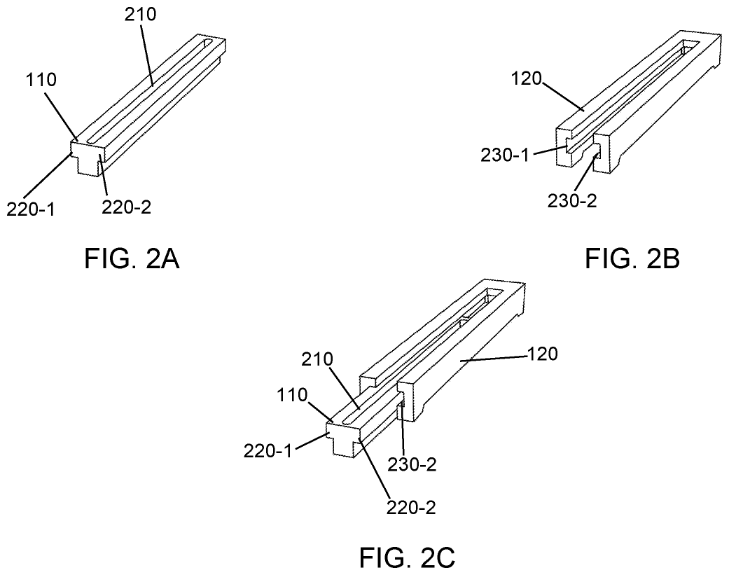

In some examples, a functional coating may be prepared by mixing hexane, fumed silica, and perfluorodecyltrichlorosilane. The silane reacts and forms a layer on the fumed silica. After waiting three days after the coating is mixed, the coating may be sprayed using an airbrush onto the milled liquid loading device 100 and a glass substrate. The coated substrate should be baked at 200° C. for several hours. The coated liquid loading device 100 should be baked at 80° C. for several hours. Next, a desired pattern may be laser ablated onto the coated substrate using a laser (e.g., a CO₂ laser, etc.). The laser selectively removes the coating, leaving patterns that are more attractive to the liquid being loaded. The liquid loading device 100 is placed on the substrate, filled with the liquid of interest (e.g., a solution, a carrier liquid bearing a biological material, a carrier liquid bearing an agent, a solvent, a solution carrying a nucleic acid, a solution carrying live or dead cells, a liquid reactant, a dissolved reactant, a solution that augments or inhibits cellular growth, a solution that elicits a target response, etc.) and the liquid loading device 100 is slid over the substrate, thereby depositing the desired amount of liquid on the patterned areas of the substrate. This configuration can load liquids with surface tensions as low as 25 mN/m. Liquid holding element 110 and carrier 120 are described in greater detail herein with respect to FIGS. 2A, 2B, and 2C.

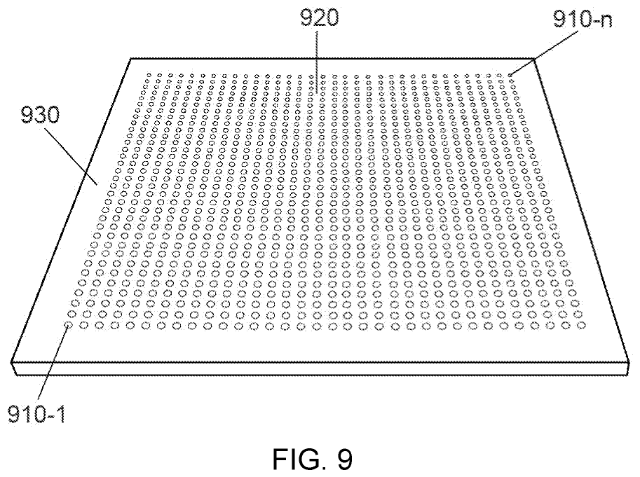

FIG. 2A is a perspective view of a liquid holding element 110, in accordance with certain examples. In an example, the liquid holding element 110 has a length in a range of 2 cm to 50 cm or any subranges therein, a width in a range of 3 mm to 5 cm or any subranges therein, and a height in a range of 2 mm to 5 cm or any subranges therein. Liquid holding element 110 comprises at least one opening 210 and extrusions 220. The at least one opening 210 functions to receive one or more liquids to be deposited onto a substrate, such as, for example, surface-patterned substrate 900 described herein in greater detail with reference to FIG. 9. The at least one opening 210 is located on a top surface of liquid holding element 110. The at least one opening 210 is connected to at least one opening 320 in a bottom surface 310 of liquid holding element 110, described in greater detail herein with reference to FIGS. 3D, 3E, and 3F. A shape of the at least one opening 210 may comprise a rectangular, a square, a circular, a trapezoidal, an oval, a polygonal, an elongated opening, or a combination thereof. The at least one opening 210 may have a dimension of 10 micrometers to 50 centimeters or any subranges therein, preferably a dimension of 10 micrometers to 5 mm. The at least one opening 210 may extend at least half, ⅔, ¾, or ⅘, including all fractional values between one half and ⅘, of the length of the liquid holding element 110. The at least one opening 110 may comprise a singular opening or a plurality of openings 210, e.g., 2-1000 openings or any integer subranges therein. Liquid holding element 110 comprises extrusions 220. Extrusions 220 may also be referred to as extensions, protrusions, or structures. In an example, extrusions 220 are symmetrical. In an example, liquid holding element 110 comprises two extrusions 220 as depicted in FIG. 2A. In an example, extrusions 220 are configured such that liquid holding element 110 may mate with carrier 120 to form liquid loading device 100. In an alternate example, not depicted, liquid holding element 110 may comprise a groove or slot to mate with an extrusion of carrier 120. In an example, liquid holding element 110 comprises a polymer, a glass, a metal, a plastic, or any combination thereof. In an example, liquid holding element 110 is reusable. In an example, liquid holding element 110 is disposable.

FIG. 2B is a perspective view of a carrier 120, in accordance with certain examples. Carrier 120 comprises grooves 230. Grooves 230 may also be referred to as slots, channels, or niches. Grooves 230 are configured such that carrier 120 may mate with liquid holding element 110. In an alternate example, not depicted, carrier 120 may comprise an extrusion to mate with a groove of liquid holding element 110. In an example, carrier 120 comprises a polymer, a glass, a metal, a wood, or any combination thereof. In an example, carrier 120 is reusable. In an example, carrier 120 is disposable.

FIG. 2C is a perspective view of a combined assembly of liquid holding element 110 and carrier 120. The combined assembly of liquid holding element 110 and carrier 120 forms liquid loading device 100. As depicted in FIG. 2C, liquid holding element 110 slides into carrier 120 such that extrusions 220 mate with grooves 230 in a T-slot type fit to secure liquid holding element into carrier 120. In an example, liquid holding element 110 is removable from carrier 120 such that a different liquid holding element 110 may be inserted. In an alternate example, liquid holding element 110 may be inserted into carrier 120 and affixed such that liquid holding element 110 may not be removed from carrier 120. Liquid holding element 110 may be affixed by an adhesive, a fastener, or any other suitable type of connecting device or material.

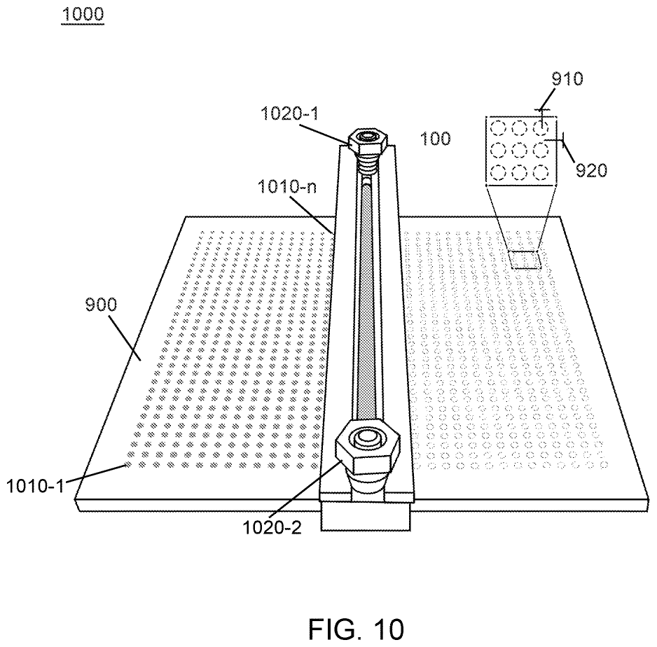

FIGS. 3A and 3B are top perspective views of example liquid loading device 100 opening(s) configurations, in accordance with certain examples. FIG. 3A depicts circular openings 210 arranged in a substantially linear orientation across the top center of liquid loading device 100. FIG. 3A depicts holes 315 which are configured to receive a fastener, screw, or other connecting device (such as, for example, fastener 1020 depicted in FIG. 10) to planarize, i.e., level, liquid loading device 100 relative to a substrate. FIG. 3B depicts a single elongated slot type opening 210.

FIG. 3C is a top view of an example liquid loading device 100 opening(s) configuration, in accordance with certain examples. FIG. 3C depicts a plurality of openings 210 configured in parallel, linear orientations. Any suitable orientation, size, shape, and quantity of openings 210 may be used.

FIGS. 3D, 3E, and 3F are bottom perspective views of example liquid holding element 110 bottom opening(s) 320 configurations. FIG. 3D depicts a bottom surface 310 of liquid holding element 110 (or alternately liquid loading device 100) and at least one bottom opening 320. A shape of the at least one bottom opening 320 may comprise a rectangular, a square, a circular, a trapezoidal, an oval, a polygonal, an elongated opening, or a combination thereof. The at least one bottom opening 320 may extend at least half, ⅔, ¾, or ⅘, including all fractional values between one half and ⅘, of the length of the liquid holding element 110. The at least one bottom opening 320 may comprise a singular opening or a plurality of openings 320, e.g., 2-1000 openings or any integer subranges therein. An opening 210 may align with and be of the same size and shape as a bottom opening 320. Alternately, a single opening 210 may taper to a smaller bottom opening 320 or a single opening 210 may enlarge to a larger bottom opening 320. FIG. 3D depicts a plurality of bottom openings 320 arranged in a substantially linear orientation across the bottom center of liquid holding element 110. FIG. 3E depicts a plurality of elongated slot type bottom openings 320. FIG. 3F depicts a single elongated slot type bottom opening 320. Any suitable orientation, size, shape, and quantity of bottom openings 320 may be used.

The interior surfaces of openings 210, bottom openings 320, and bottom surface 310 may be coated. The coating may prevent liquids from adhering to or becoming stuck to the interior surfaces of openings 210 and bottom openings 320. The coating may prevent liquids from adhering to bottom surface 310 and provide ease of deposition of liquids to a substrate, such as, for example, surface-patterned substrate 900. The coating may prevent liquids from spilling out from the intended confined location in the liquid loading device 100. In an example, the coating may comprise a hydrophobic, omniphobic, oleophobic, superhydrophobic, superomniphobic, or superoleophobic coating, or any combination thereof. In an example, the interior surfaces of openings 210 are coated with a slippery coating. In an example, the interior surfaces of openings 210 and bottom openings 320 are coated with a material selected from silane, Polydimethylsiloxane (“PDMS”), or any other low surface energy material having a surface tension of less than 40, 39, 38, 37, 36, 35, 34, 33, 32, 31, 30, 29, 28, 27, 26, 25, 24, 23, 22, 21, 20, 19, 18, or 17 mJ/m² or mN/m.

Examples of suitable omniphobic coatings and uperomniphobic coatings are known in the art. In various examples, an omniphobic coating or a superomniphobic coating comprise fluorinated silicone nanofilaments, electrospun fibers and FluoroPOSS compounds, hierarchical textures, reentrant and double-reentrant nanopatterned coatings, fluorinated fumed silica, fluorinated silica templated off of candle soot, fluorinated “urchin”-like particles of alumina, nanoparticles synthesized by flame spray pyrolysis then fluorinated, and the like.

Examples of hydrophobic coatings are known in the art. In various examples, hydrophobic coatings comprise untextured fluorinated and alkylated surfaces, untextured poly(dimethyl siloxane) surfaces, and the like.

Examples of superhydrophobic coatings are known in the art. In various examples, a superhydrophobic coating comprises candle soot, textured poly(dimethyl siloxane), other textured fluorinated and alkylated surfaces and the like.

In various examples a coating is a “slippery” surface. In various examples, a “slippery” surface comprises slippery liquid-infused porous surfaces (SLIPS) and variants thereof, slippery omniphobic covalently attached liquid (SOCAL) surfaces, or the like.

Herein, hydrophobic is defined as a surface presenting a contact angle for a droplet of water of greater than 90 degrees, as measured with a goniometer.

Herein, hydrophilic is defined as a surface presenting a contact angle for a droplet of water of less than 90 degrees, as measured with a goniometer.

Herein, oleophobic is defined as a surface presenting a contact angle for a droplet of hexadecane of greater than 90 degrees, as measured with a goniometer.

Herein, oleophilic is defined as a surface presenting a contact angle for a droplet of hexadecane of less than 90 degrees, as measured with a goniometer.

Herein, omniphobic is defined as a surface presenting a contact angle for a droplet of hexadecane of greater than 90 degrees and a contact angle for a droplet of water of greater than 90 degrees, as measured with a goniometer.

Herein, omniphilic is defined as a surface presenting a contact angle for a droplet of hexadecane of less than 90 degrees and a contact angle for a droplet of water of less than 90 degrees, as measured with a goniometer.

Herein, superoleophobic is defined as a surface presenting a contact angle for a droplet of hexadecane of greater than 150 degrees, as measured with a goniometer.

Herein, superoleophilic is defined as a surface presenting a contact angle for a droplet of hexadecane of less than 10 degrees, as measured with a goniometer.

Herein, superhydrophobic is defined as a surface presenting a contact angle for a droplet of water of greater than 150 degrees, as measured with a goniometer.

Herein, superhydrophilic is defined as a surface presenting a contact angle for a droplet of water of less than 10 degrees, as measured with a goniometer.

Herein, superomniphobic is defined as a surface presenting a contact angle for a droplet of hexadecane of greater than 150 degrees and a contact angle for a droplet of water of greater than 150 degrees, as measured with a goniometer.

Herein, superomniphilic is defined as a surface presenting a contact angle for a droplet of hexadecane of less than 10 degrees and a contact angle for a droplet of water of less than 10 degrees, as measured with a goniometer.

The above definitions refer to the Young's contact angle (the equilibrium contact angle), in instances where contact angle hysteresis exists, we specify these quantities for the advancing contact angle.

Slippery surfaces are defined as having a sliding angle for a 10 microliter droplet of less than 20 degrees tilt.

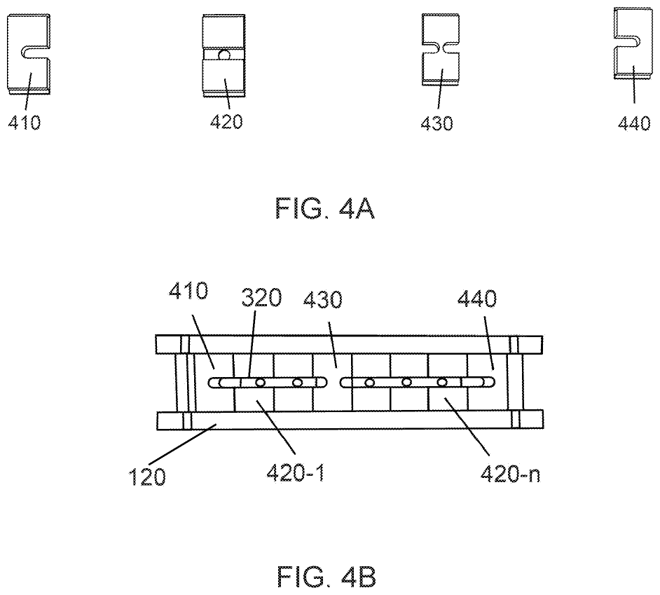

FIG. 4A depicts example embodiments of interchangeable liquid distribution blocks, in accordance with certain examples. Liquid holding element 110 may be constructed of interchangeable liquid distribution blocks inserted into a frame to customize the size, shape, and quantity of openings 210 and bottom openings 320. In an example and as depicted in FIG. 4A, opening 320 may be an elongated shape with a circular top opening 210. In a bottom perspective view, interchangeable liquid distribution block 410 is closed in a leftward direction and starts a bottom opening 320 in a rightward direction (i.e., right opening block 410). Interchangeable liquid distribution block 410 may be positioned adjacent to one or more interior interchangeable liquid distribution blocks 420 to extend the size of opening 320 (i.e., interior block 420 opening both to the left and right). When a desired size of opening 320 is achieved, opening 320 may be closed with the placement of interchangeable liquid distribution block 440, which has a leftward opening and is closed in a rightward direction (i.e., left opening block 440). If more than one opening 320 is desired, interchangeable liquid distribution block 430 may be used to close a first opening 320 and start a second opening 320 (i.e., transition block 430). The start of second opening 320 may be positioned adjacent to one or more interchangeable liquid distribution blocks 420 to extend the size of second opening 320. When a desired size of second opening 320 is achieved, opening 320 may be closed with the placement of interchangeable liquid distribution block 440. If more openings 320 are desired, the process of positioning interchangeable liquid distribution blocks may continue.

FIG. 4B is a bottom view of a liquid loading device comprising interchangeable liquid distribution blocks, in accordance with certain examples. In the embodiment of FIG. 4B, liquid loading device 110 comprises a first opening 320 with a right opening block 410 following by two interior blocks 420. A transition block 430 starts a second opening 320 followed by three interior blocks 420. The second opening 320 is closed by a left opening block 440. The interchangeable liquid distribution blocks are inserted into carrier 120 to form liquid loading device 100.

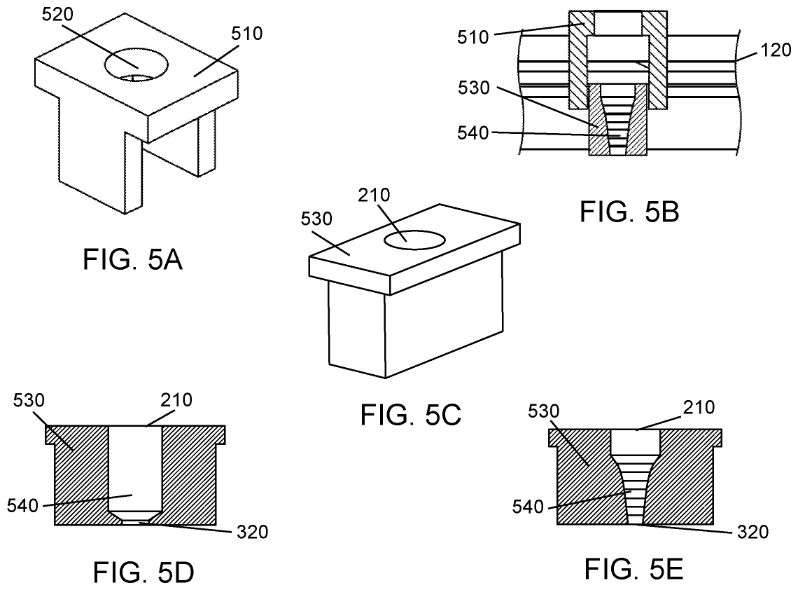

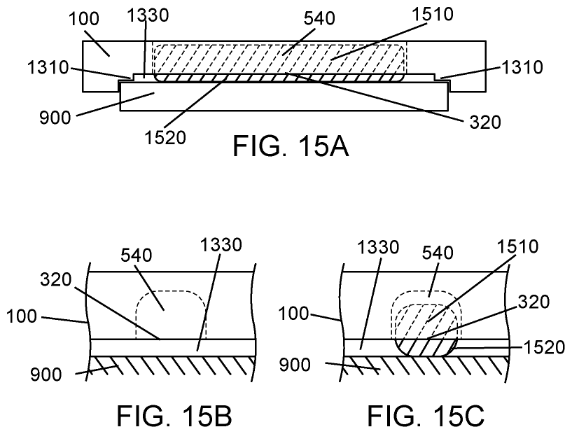

As an alternative to the interchangeable liquid distribution blocks described with reference to FIGS. 4A and 4B, individual blocks may be constructed to further customize liquid holding element 110. FIG. 5A is a top perspective view of an example small volume loader holding device 510, in accordance with certain examples. FIG. 5A depicts a small volume loader holding device 510 with top opening 520. Top opening 520 is configured to allow liquid to be loaded into a small volume loader device 530 and to position small volume loader device 530 within carrier 120. FIG. 5B is a cross-sectional front view of an example small volume loader assembly, in accordance with certain examples. A small volume loader device 530 is inserted into carrier 120 with small volume loader holding device 510 affixed above small volume loader device 530 to form the assembly. The assembly depicts a reservoir 540 to confine one or more liquid(s), such as, for example, the one or more liquids 1510 described herein with reference to FIG. 15A. FIG. 5C is a top perspective view of an example small volume loader device. FIGS. 5D and 5E are example cross-sectional side views of further examples of small volume loader devices. FIG. 5D depicts a small volume loader device 530 with a substantially cylindrical cross section through-hole defining a reservoir 540 until close to the bottom of the small volume loader device 530, where the through-hole sharply tapers. In this embodiment, opening 210 is larger in diameter than bottom opening 320. FIG. 5E depicts a small volume loader device 530 with an initially substantially cylindrical cross section through-hole defining a reservoir 540 that gradually tapers to a smaller diameter at the bottom of the small volume loader device 530. In this embodiment, opening 210 is larger in diameter than bottom opening 320. In an example embodiment and in reference to the cross section depicted in FIG. 5E, the cross section is a tapered design for the section of the small volume loader device 530 containing liquid. As the liquid height is reduced, the hydrostatic pressure at the bottom of the small volume loader device 530 falls, which could reduce the volume dispensed into each receiving portion of the surface-patterned substrate 900. A radius of the section of the small volume loader device 530 containing the liquid may be adjusted to compensate, providing an increased Laplace pressure to offset the diminishing hydrostatic pressure, for a given liquid and contact angle of the liquid with the walls of the section of the loading device containing the liquid.

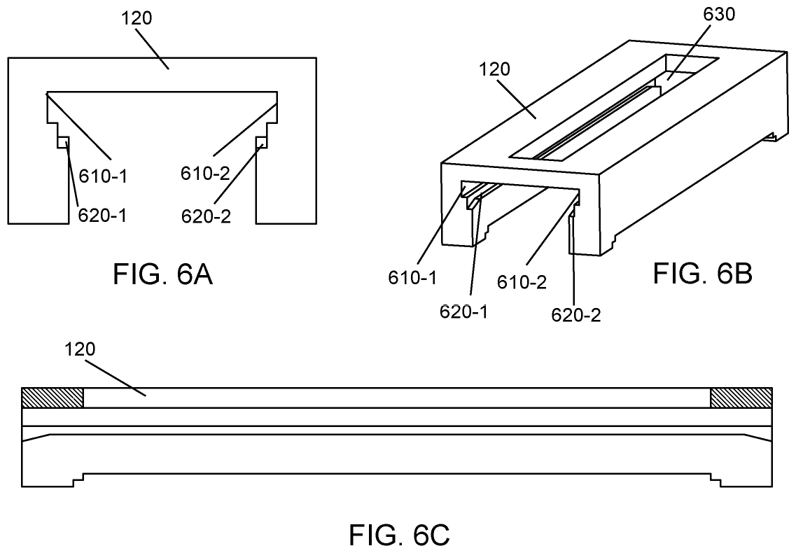

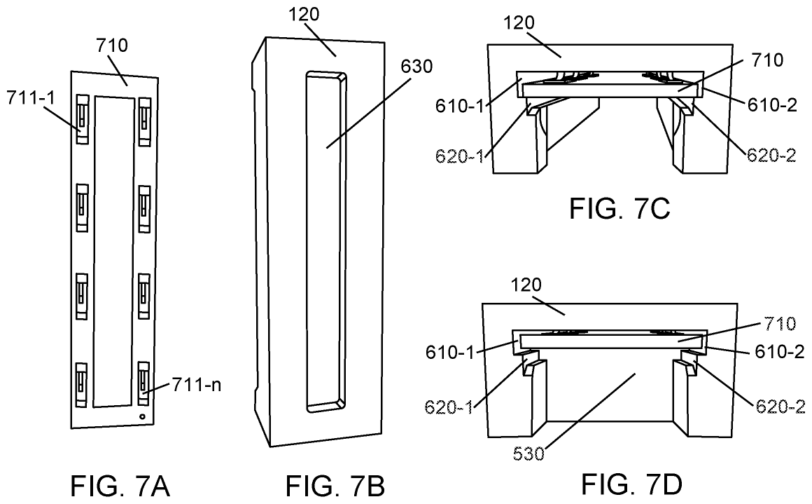

FIG. 6A is a side view of an alternate embodiment of a carrier 120. In the embodiment of FIG. 6A, carrier 120 is configured to accept liquid holding element 110, interchangeable liquid distribution blocks described herein with reference to FIGS. 4A and 4B, or small volume loader devices 530 described herein with reference to FIGS. 5A through 5E. In an example, carrier 120 is configured to accept an insertable gap control board 710 described herein with reference to FIG. 7A. Carrier 120 comprises insertable gap control board grooves 610 and bottom element grooves 620, wherein bottom element grooves 620 are configured to accept liquid holding element 110, interchangeable liquid distribution blocks, or small volume loader devices 530. FIG. 6B is a perspective view of the alternate embodiment of a carrier 120, in accordance with certain examples. FIG. 6B depicts a top opening 630 in carrier 120. FIG. 6C is a cross-sectional front view of an alternate embodiment of a carrier 120, in accordance with certain examples.

FIG. 7A is a top view of an example insertable gap control board 710, in accordance with certain examples. Insertable gap control board 710 is a thin, flat board configured to be inserted into a carrier 120, such as, for example, the embodiment described herein with reference to FIG. 6A. Insertable gap control board 710 is configured to constrain liquid holding element 110 (or interchangeable liquid distribution blocks or small volume loader devices 530) to the bottom of element grooves 620 through means of a pressure or force. In an example, a thickness of the gap region is adjustable within a range of 0-1 cm, preferably 0-5 mm, or any subranges there. The thickness of the gap region is adjustable and maintained by a plurality of gap springs 711. In an example, a height of gap springs 711 may be adjustable. In an alternate example, gap springs 711 may be interchangeable with gap springs 711 of a different height to alter a thickness of the gap region.

FIG. 7B is a top perspective view of an alternate embodiment of a carrier 120 with top opening 630. FIG. 7C is a side perspective view of an assembly of an insertable gap control board 710 and a carrier 120. Insertable gap control board 710 is inserted into grooves 610. FIG. 7D is a side perspective view of an assembly of an insertable gap control board 710, a carrier 120, and a small volume loader device 530. In an alternate example, a liquid holding element 110 or interchangeable liquid distribution blocks may replace small volume loader device 530.

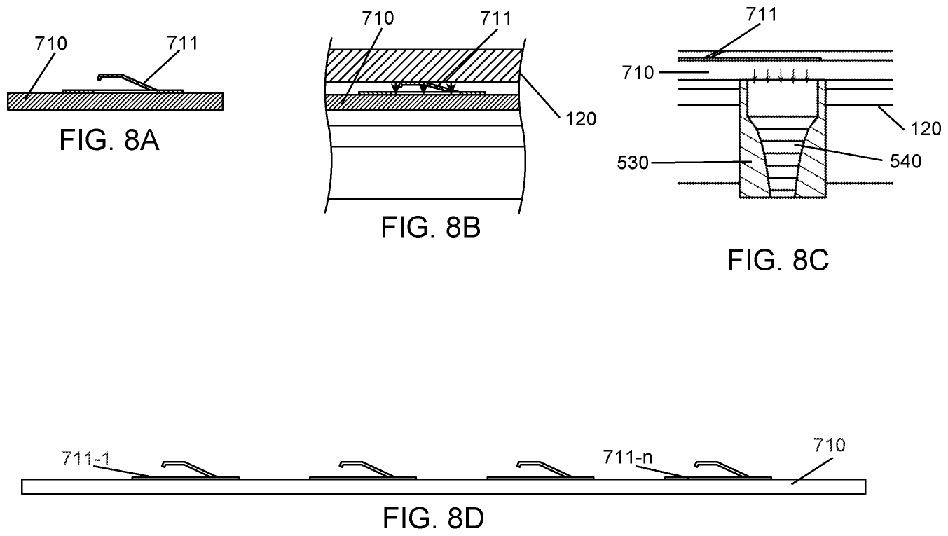

FIG. 8A is a cross-sectional front view of an example insertable gap control board 710, in accordance with certain examples. FIG. 8A depicts a side perspective view of a gap spring 711. FIG. 8B is a cross-sectional front view of an assembly of an insertable gap control board 710 and a carrier 120 with a gap spring 711, in accordance with certain examples. FIG. 8C is a cross-sectional front view of an assembly of an insertable gap control board 710, a carrier 120, and a small volume loader device 530 with a reservoir 540, in accordance with certain examples. The arrows in FIG. 8C represent a pressure or force applied to small volume loader device 530 by gap control board 710. In an alternate example, a liquid holding element 110 or interchangeable liquid distribution blocks may replace small volume loader device 530. FIG. 8D is a front view of an insertable gap control board 710 with a plurality of gap springs 711, in accordance with certain examples.

FIG. 9 is a perspective view of a surface-patterned substrate 900, in accordance with certain examples. Surface-patterned substrate 900 enables parallel manipulation (e.g., of hundreds to tens of thousands) of independent liquid mixtures or volumes (e.g., in minutes and/or at volumes down to 10 nanoliters) without the use of a unique pipette tip for each liquid deposition at each location. Surface-patterned substrate 900 is a flat substrate with defined regions to selectively repel and attract liquids in predefined patterns. Surface-patterned substrate 900 leverages capillarity to precisely meter and control liquid volumes. Surface-patterned substrate 900 comprises a plurality of a first region 910 configured to attract one or more liquids loaded in liquid loading device 100. The plurality of the first region 910 comprises a coating such that the plurality of the first region 910 has a contact angle of less than 90 degrees relative to one or more liquids loaded in liquid loading device 100. In an example, the coating is a hydrophilic, oleophilic, or omniphilic coating. In an example, the coating is a high surface energy coating. In an example, the first region 910 is the substrate surface. In an example, the first region 910 is a glass substrate surface. In an example, the plurality of the first region 910 may comprise a shape of a circle, rectangle, square, trapezoid, oval, polygon, or any combination thereof. Surface-patterned substrate 900 comprises one or more of a second region(s) 920 located to surround the plurality of the first region. The one or more of the second region(s) 920 configured to repel the one or more liquids loaded in liquid loading device 100. The one or more of the second region(s) 920 comprises a coating such that the one or more of the second region(s) 920 has a contact angle of greater than the contact angle on region 910 to one or more liquids loaded in liquid loading device 100. In an example, the one or more of the second region(s) 920 comprises a coating such that the one or more of the second region(s) 920 has a contact angle of greater than 150 degrees relative to one or more liquids loaded in liquid loading device 100. In an example, the coating is a hydrophobic, omniphobic, oleophobic, superhydrophobic, superomniphobic, or superoleophobic coating. In an example, the coating is a low surface energy coating. In an example, the plurality of the first region and the one or more second region(s) 920 are in a same plane as top surface 930 of the surface-patterned substrate 900. In an alternate example, the one or more second region(s) are in a same plane as top surface 930 of the surface-patterned substrate 900 and the plurality of the first region are disposed in a lower position relative to the one or more second region(s). For example, the plurality of the first region may be wells or indentations in surface-patterned substrate 900. In the example, the well may have a depth of 0 to 3 mm, including all 0.1 mm values and ranges therebetween relative, to top surface 930 of the surface-patterned substrate 900. In an example, the plurality of the first region 910 are of the same area and are configured to receive the same volume. In an example, the plurality of the first region 910 are of the different areas and are configured to receive different volumes. In an example, the plurality of the first region 910 are arranged in a regular pattern, such as, for example, a grid. In an example, the plurality of the first region 910 are in an irregular pattern, such as, for example, a grid with one or more missing first region(s) 910.

FIG. 10 is a perspective view of an example liquid dispensing system 1000, in accordance with certain examples. Liquid dispensing system 1000 comprises liquid loading device 100 and a surface-patterned substrate 900. As the example liquid loading device 100 moves relative to surface patterned substrate 900, one or more liquid(s) 1010 are deposited on surface-patterned substrate 900 and into one or more of the plurality of the first regions 910, previously discussed herein with reference to FIG. 9. In an example, at least some of the one or more liquid(s) 1010-1-1010-n borne within the first regions 910-1-910-n may comprise a volume in a range from 10 nanoliters to 10 microliters, including all integer nanoliter values and ranges therebetween. Although liquid depending from the opening(s) in the liquid loading device 100 may contact the one or more second region(s) 920, the liquid is not deposited on the one or more second region(s) 920 due to discontinuous wetting. In an example, a gap height 1330, discussed in greater detail herein with reference to FIGS. 13A through 13E, between the bottom surface 310 of the liquid loading device 100 and the top surface 930 of the surface-patterned substrate 900 may be used to control a volume of the one or more liquid(s) 1010. In an example, a size of each of the one or more of the plurality of the first region 910 may be used to control a volume of the one or more liquid(s) 1010. In an example, a volume of each of the first regions 910-1-910-n configured to receive the one or more liquid(s) 1010-1-1010n therein may be the same. In an alternate example, a volume of each of the first regions 910-1-910-n configured to receive the one or more liquids 1010-1-1010-n may vary (e.g., increase in diameter, depth, and/or cross-sectional profile along a first direction and/or a second direction, decrease in diameter, depth, and/or cross-sectional profile along a first direction and/or a second direction, etc.) across surface-patterned substrate 900. FIG. 10 also depicts fasteners 1020 (e.g., screws, bolts, or other connecting devices) which are configured to mate with holes 315 to planarize, i.e., level, liquid loading device 100 relative to the surface-patterned substrate 900, for example by means of clamping to planar rigid bars.

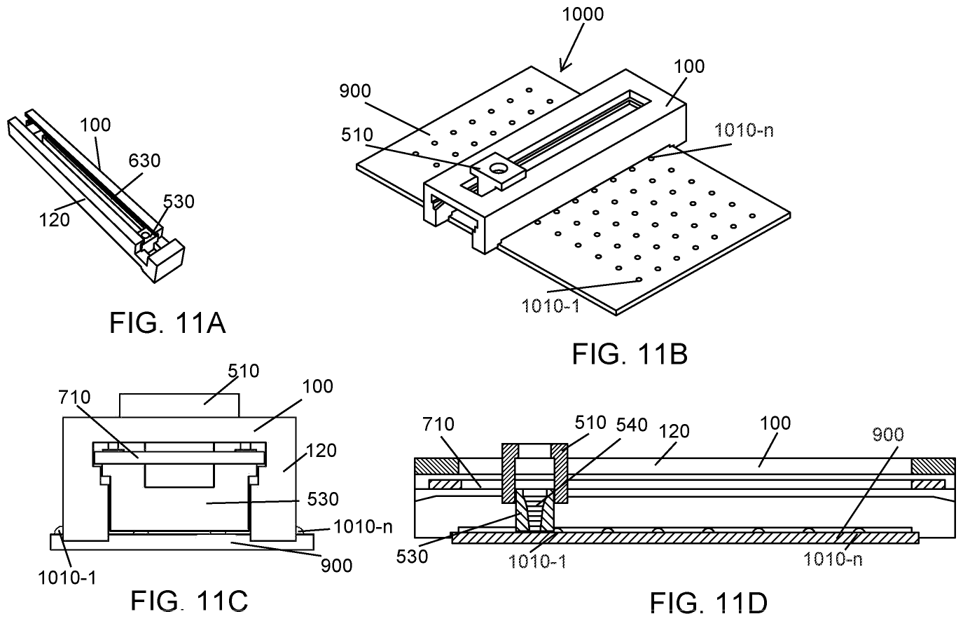

FIG. 11A is a top perspective view of an example embodiment of a liquid loading device 100, in accordance with certain examples. As previously discussed herein, liquid loading device 100 comprises a housing 120, a small volume loader device 530, and a top opening 630. In an alternate example, a liquid holding element 110 or interchangeable liquid distribution blocks may replace small volume loader device 530.

FIG. 11B is a top perspective view of an example embodiment of a liquid dispensing system 1000, in accordance with certain examples. FIG. 11B depicts liquid loading device 100, surface-patterned substrate 900, and a small volume loader holding device 510 A small volume loader device 530 is obscured beneath the small volume loader holding device 510. Surface-patterned substrate 900 contains a plurality of deposited liquid mixtures 1010-1-1010-n. In an alternate example, a liquid holding element 110 or interchangeable liquid distribution blocks may replace small volume loader device 530.

FIG. 11C is a side view of a liquid dispensing system 1000, in accordance with certain examples. FIG. 11C depicts a liquid loading device 100 with housing 120 positioned above a surface-patterned substrate 900. Liquid loading device 100 is illustrated with a small volume loader holding device 510, a small volume loader device 530, and an insertable gap control board 710. Surface-patterned substrate 900 contains a plurality of deposited liquid mixtures 1010-1-1010-n.

FIG. 11D is a front view of a liquid dispensing system 1000, in accordance with certain examples. FIG. 11D depicts liquid loading device 100 with housing 120 positioned above surface-patterned substrate 900. Liquid loading device 100 is illustrated with an insertable gap control board 710. FIG. 11D depicts a small volume loader holding device 510. A small volume loader device 530 is depicted beneath the small volume loader holding device 510 with reservoir 540. Surface-patterned substrate 900 contains a plurality of deposited liquid mixtures 1010-1-1010-n. In an alternate example, a liquid holding element 110 or interchangeable liquid distribution blocks may replace small volume loader device 530.

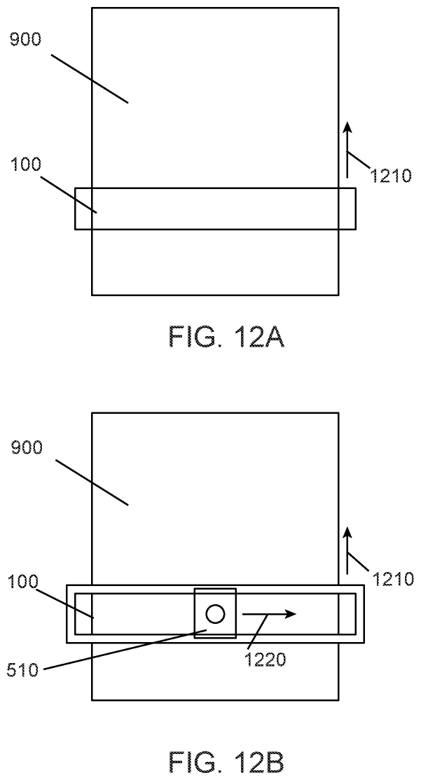

FIGS. 12A and 12B are top views of example embodiments indicating example direction(s) of movement of components of a liquid dispensing system 1000, in accordance with certain examples. FIG. 12A depicts liquid loading device 100 in motion relative to the surface-patterned substrate 900 along a longitudinal direction as depicted by arrow 1210. In an example, liquid loading device 100 may be configured for motion (e.g., translation and/or rotation along one or more axes) relative to a statically-disposed surface-patterned substrate 900. In an example, surface-patterned substrate 900 may be configured for motion (e.g., translation and/or rotation along one or more axes) relative to a statically-disposed liquid loading device 100. In an example, both the liquid loading device 100 and the surface-patterned substrate 900 may both be independently configured for motion relative to each other. FIG. 12B depicts liquid loading device 100 in motion, as represented by the arrow 1210, relative to the surface-patterned substrate 900 along a longitudinal direction as the small volume loader device 530 is also in motion, as represented by the arrow 1220, relative to the liquid loading device 100. In some examples, the small volume loader device 530 may be configured to translate along the liquid loading device 100 while the liquid loading device 100 is held stationary relative to the surface-patterned substrate 900. In some examples, the small volume loader device 530 may be configured to translate along the liquid loading device 100 while the liquid loading device 100 is in motion relative to surface-patterned substrate 900.

FIGS. 13A, 13B, 13C, 13D, and 13E are cross-sectional front views of liquid dispensing systems 1000 with example spacer elements 1310, in accordance with certain examples. FIG. 13A depicts a liquid loading device 100 positioned above a surface-patterned substrate 900. Spacer elements 1310 are affixed to or defined by the liquid loading device 100 to create a gap 1330. Liquid loading device 100 comprises a lip 1320 to constrain lateral motion of surface-patterned substrate 900 relative to liquid loading device 100.

FIG. 13B depicts a liquid loading device 100 positioned above a surface-patterned substrate 900. Spacer elements 1310 are affixed to or defined by the surface-patterned substrate 900 to create a gap 1330. Liquid loading device 100 comprises a lip 1320 to constrain lateral motion of surface-patterned substrate 900 relative to liquid loading device 100.

FIG. 13C depicts a liquid loading device 100 positioned above a surface-patterned substrate 900. Spacer elements 1310 are free spacer elements positioned between liquid loading device 100 and surface-patterned substrate 900 to create a gap 1330. In an example, gap 1330 has a height of 0-1 cm, preferably 0-3 mm, including all 0.1 mm values and ranges therebetween. Liquid loading device 100 comprises a lip 1320 to constrain lateral motion of surface-patterned substrate 900 relative to liquid loading device 100.

FIG. 13D depicts a liquid loading device 100 positioned above a surface-patterned substrate 900. Lateral sidewalls 1340 of a liquid loading device 100 are in contact with an external surface 1345 to create a gap 1330 between a liquid loading device 100 and a surface-patterned substrate 900.

FIG. 13E depicts a liquid loading device 100 positioned above a surface-patterned substrate 900. In this example, an external frame 1350 is configured to create a gap 1330 between liquid loading device 100 and surface-patterned substrate 900. In an example, the external frame 1350 may be affixed to liquid loading device 100. In an example, a height of the external frame 1350 may be advantageously adjustable to a plurality of heights to permit selective adjustment of a height of the gap 1330.

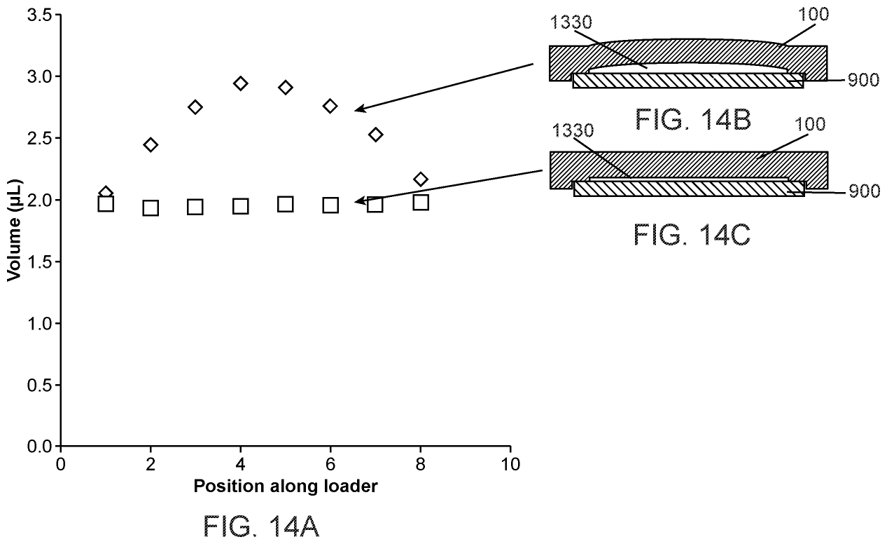

FIG. 14A is a graphical depiction of example liquid volume distributions, in accordance with certain examples. FIG. 14A depicts liquid volume quantities relative to a position along liquid loading device 100 corresponding to embodiments of liquid dispensing systems 1000 depicted in FIGS. 14B and 14C. In FIG. 14A, the top liquid volume distribution corresponds to the embodiment of liquid dispensing system 1000 depicted in FIG. 14B. FIG. 14B is a cross-sectional front view of an example embodiment of liquid dispensing system 1000, in accordance with certain examples. FIG. 14B depicts a variable size gap 1330 such that a height of gap 1330 is less at the ends of liquid loading device 100 relative to a height of gap 1330 in the center of liquid loading device 100. The height distribution of gap 1330 depicted in FIG. 14B corresponds to the liquid volume distribution depicted in FIG. 14A.

In FIG. 14A, the bottom liquid volume distribution corresponds to the embodiment of liquid dispensing system 1000 depicted in FIG. 14C. FIG. 14C is a cross-sectional front view of an example embodiment of liquid dispensing system 1000, in accordance with certain examples. FIG. 14C depicts a substantially uniform gap 1330 such that a height of gap 1330 the same across the liquid loading device 100. The uniform height of gap 1330 depicted in FIG. 14C corresponds to the liquid volume distribution depicted in FIG. 14A.

FIG. 15A is a front view of an example embodiment of a liquid dispensing system 1000 with an elongated through-hole dimensioned to confine liquid 1510 in the liquid loading device 100, in accordance with certain examples. FIG. 15A depicts the liquid loading device 100 positioned above the surface-patterned substrate 900, bottom opening 320, liquid 1510 within the reservoir 540 of the liquid loading device 100, depending liquid 1520, spacer elements 1310, and gap 1330.

FIG. 15B is a side view of a liquid dispensing system 1000 depicting an optional indentation for confining liquid in the liquid loading device 100, in accordance with certain examples. FIG. 15B depicts liquid loading device 100 positioned above surface-patterned substrate 900, bottom opening 320, reservoir 540, and gap 1330.

FIG. 15C is a side view of a liquid dispensing system 1000 depicting an indentation for confining liquid with liquid 1510 confined therein, in accordance with certain examples. FIG. 15C depicts liquid loading device 100 positioned above surface-patterned substrate 900, bottom opening 320, liquid 1510 within the reservoir 540 of the liquid loading device 100, depending liquid 1520, and gap 1330.

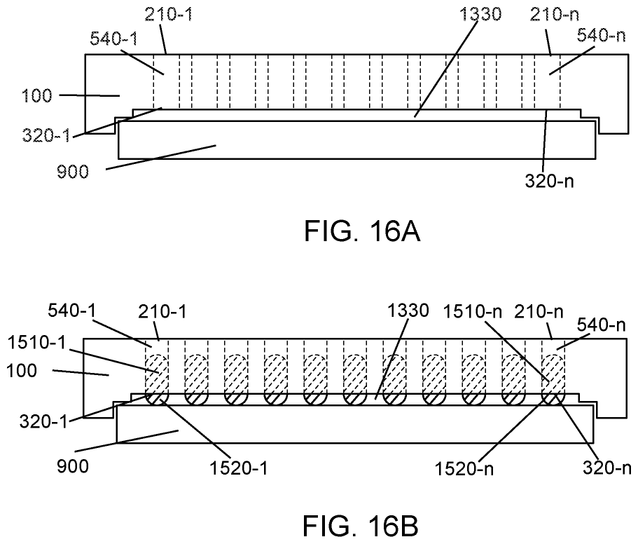

FIG. 16A is a front view of an example embodiment of a liquid dispensing system 1000 with multiple liquid loading device openings, in accordance with certain examples. FIG. 16A depicts a liquid loading device 100 positioned above a surface-patterned substrate 900, a plurality of openings 210-1-210-n, a plurality of bottom openings 320-1-320-n, a plurality of reservoirs 540-1-540-n, and a gap 1330.

FIG. 16B is a front view of an example embodiment of a liquid dispensing system 1000 with multiple liquid loading device openings comprising one or more liquid(s) 1510, in accordance with certain examples. FIG. 16B depicts a liquid loading device 100 positioned above a surface-patterned substrate 900, a plurality of openings 210-1-210-n, a plurality of bottom openings 320-1-320-n, a plurality of reservoirs 540-1-540-n confining liquid(s) 1510-1-1510-n, a plurality of depending liquid(s) 1520-1-1520-n, and a gap 1330.

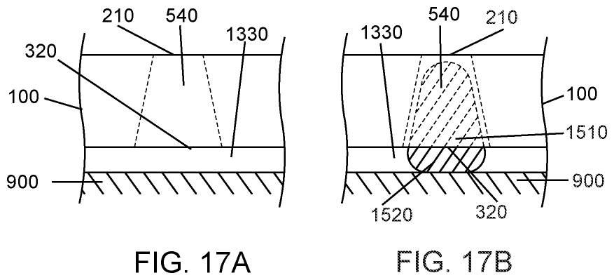

FIG. 17A is a side view of a liquid dispensing system 1000 comprising an example tapered through-hole for confining liquid in liquid loading device 100, in accordance with certain examples. FIG. 17A depicts a liquid loading device 100 positioned above a surface-patterned substrate 900, opening 210, bottom opening 320, reservoir 540, and gap 1330.

FIG. 17B is a side view of a liquid dispensing system 1000 comprising an example tapered through-hole for confining liquid 1510 in the liquid loading device 100, in accordance with certain examples. FIG. 17B depicts liquid loading device 100 positioned above surface-patterned substrate 900, opening 210, bottom opening 320, liquid 1510 within the reservoir 540 of the liquid loading device 100, depending liquid 1520, and gap 1330.

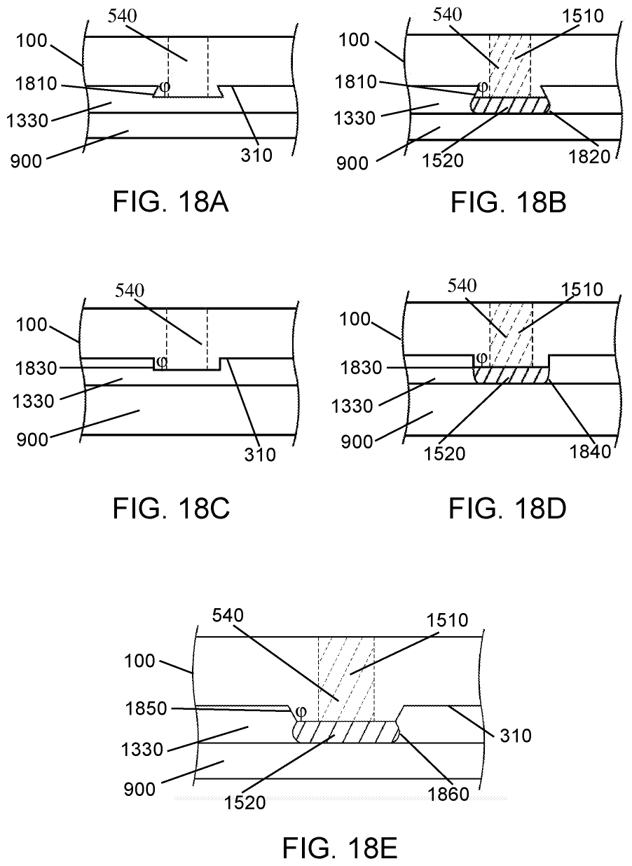

FIGS. 18A, 18B, 18C, 18D, and 18E depict side views of example embodiments of liquid dispensing systems 1000 with varying geometrical liquid loading device 100 to surface-patterned substrate 900 interfaces, in accordance with certain examples. FIG. 18A depicts a liquid loading device 100 positioned above a surface-patterned substrate 900. The bottom surface 310 comprises geometrical feature 1810. Geometrical feature 1810 is a protrusion from bottom surface 310 with an acute angle o relative to a horizontal. FIG. 18B depicts the embodiment of FIG. 18A with liquid 1510 within the reservoir 540 of the liquid loading device 100 and depending liquid 1520 pinned at geometrical feature 1810 and touching surface-patterned substrate 900 with geometrical profile 1820.

FIG. 18C depicts a liquid loading device 100 positioned above a surface-patterned substrate 900. The bottom surface 310 comprises geometrical feature 1830. Geometrical feature 1830 is a protrusion from bottom surface 310 with right angle o relative to a horizontal. FIG. 18D depicts the embodiment of FIG. 18C with liquid 1510 within the reservoir 540 of the liquid loading device 100 and depending liquid 1520 pinned at geometrical feature 1830 and touching surface-patterned substrate 900 with geometrical profile 1840.

FIG. 18E depicts liquid loading device 100 positioned above surface-patterned substrate 900. The bottom surface 310 comprises geometrical feature 1850. Geometrical feature 1850 is a protrusion from bottom surface 310 with an obtuse angle o relative to a horizontal with liquid 1510 within the reservoir 540 of the liquid loading device 100 and depending liquid 1520 pinned at geometrical feature 1850 and touching surface-patterned substrate 900 with geometrical profile 1860.

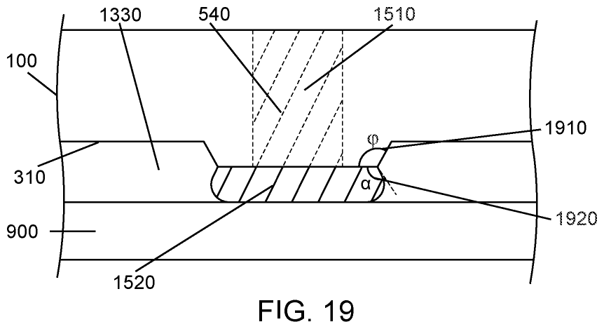

FIG. 19 is a side view of an example embodiment of a liquid dispensing system 1000 depicting a geometrical configuration of liquid pinned beneath the liquid loading device 100 and above the surface-patterned substrate 900, in accordance with certain examples. FIG. 19 depicts a liquid loading device 100 positioned above a surface-patterned substrate 900. In an example, the liquid contact angle with the substrate 900 is high, depicted in FIG. 19 as an idealized It radians. Geometrical feature 1910 is a protrusion from bottom surface 310 with an angle o relative to a horizontal with liquid 1510 within the reservoir 540 of the liquid loading device 100 and depending liquid 1520 pinned at geometrical feature 1910 and touching surface-patterned substrate 900 at an angle α (1920). In an example, the radius of the confinement section (i.e., radius of opening 210), contact angle of the liquid with surface-patterned substrate 900, pressure of liquid 1510, and gap 1330 between liquid loading device 100 and surface-patterned substrate 900 are configured such that α<π−φ+θ₁, where θ₁ is the contact angle with bottom surface 310, to avoid liquid 1520 spilling beyond the confinement feature. Note that φ=πcorresponds to a flat-bottomed liquid loading device 100, which is still able to confine liquid provided that θ₁ is sufficiently large. Liquid 1520 can also be confined with a small θ₁, provided o is large enough. Maximum pressure is supported when α=T, which can be achieved with any 100 =θ₁. In a preferred embodiment, a large θ₁ and small φ will maximize liquid loading device 100 robustness to defects in preventing liquid spilling beyond the confinement.

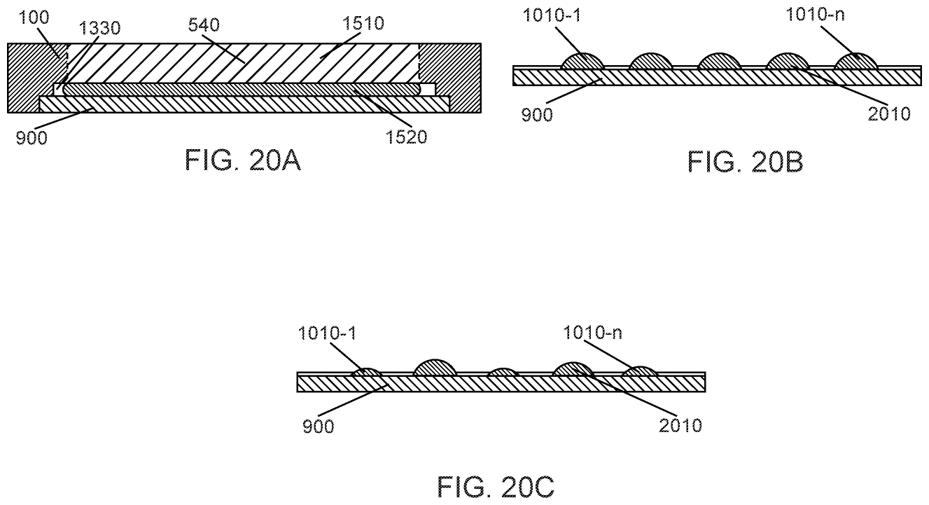

FIG. 20A is a front view of an example embodiment of a liquid dispensing system 1000, in accordance with certain examples. FIG. 20A depicts liquid loading device 100 positioned above surface-patterned substrate 900 with liquid 1510 within the reservoir 540 of the liquid loading device 100 and depending liquid 1520 pinned at surface-patterned substrate 900, gap 1330, and one or more liquid(s) 1510. The liquid 1510 is initially confined within the reservoir 540 of the liquid loading device 100 to be transferred to the surface-patterned substrate 900.

FIG. 20B is a cross-sectional front view of an example liquid distribution pattern 2010, in accordance with certain examples. The combination of gap 1330, geometrical features of liquid loading device 100, and the areas of first regions 910 produce the liquid distribution pattern 2010 depicted in FIG. 20B.

FIG. 20C is a cross-sectional front view of an example liquid distribution pattern 2010, in accordance with certain examples. The combination of gap 1330 and geometrical features of liquid loading device 100 produce the liquid distribution pattern 2010 depicted in FIG. 20C.

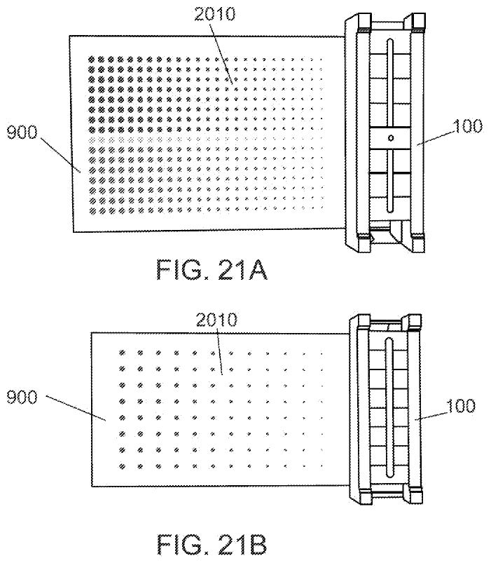

FIGS. 21A and 21B are top perspective views of example liquid distribution patterns 2010 for example liquid dispensing systems 1000, in accordance with certain examples. Note that liquid loading devices 100 have been flipped from the usual loading configuration in this figure to display otherwise obscured features.

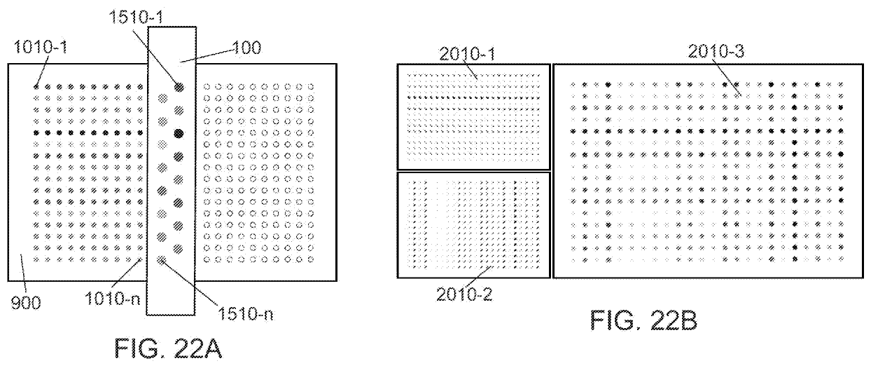

FIG. 22A is a top view of a liquid loading device 100 confining and distributing multiple liquids 1510 on a surface-patterned substrate 900, in accordance with certain examples. FIG. 22A depicts a liquid loading device 100 positioned above a surface-patterned substrate 900 with a plurality of deposited liquid mixtures 1010-1-1010-n pinned at surface-patterned substrate 900. Liquid loading device 100 is depicted confining and loading multiple liquids 1510-1-1510-n simultaneously.

FIG. 22B is a top view of surface-patterned substrates with varying liquid distribution patterns 2010, in accordance with certain examples. FIG. 22B depicts a liquid distribution pattern 2010-1 where deposited liquid mixtures 1010 vary by rows on surface-patterned substrate 900. FIG. 22B depicts a liquid distribution pattern 2010-2 where deposited liquid mixtures 1010 vary by columns on surface-patterned substrate 900. FIG. 22B depicts a liquid distribution pattern 2010-3 resulting from the sandwiching and mixing of the liquid distribution pattern 2010-1 and 2010-2.

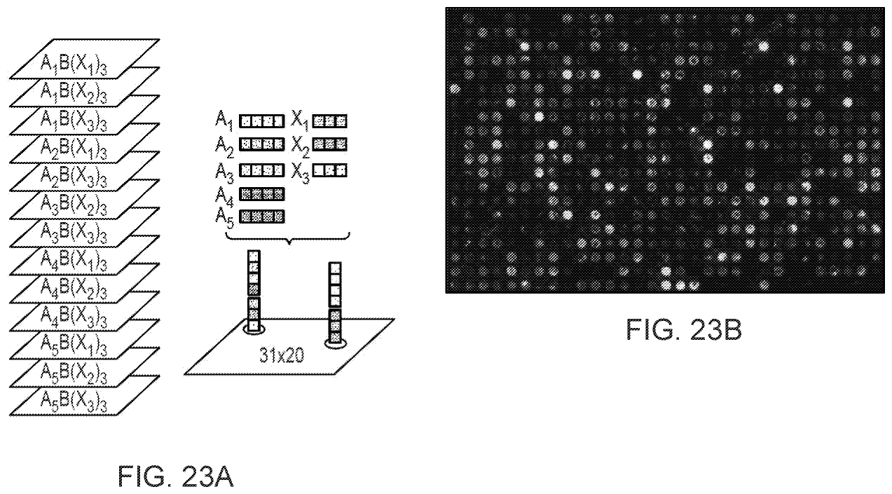

FIGS. 23A and 23B depict an example application of a liquid dispensing system 1000 related to combinatorial materials, in accordance with certain examples. The mixtures of perovskite (ABX3) precursor salts (AX and BX2) comprising a combination of five different cationic A site substitutions (methylammonium, formamidinium, cesium, phenethylammonium and rubidium) and three different anionic X site substitutions (chlorine, bromine, and iodine) are prepared separately in dimethyl sulfoxide (DMSO) solvent. This gives fifteen such mixtures, but due to solubility limitations, only 13 were usable. First, a surface-patterned substrate 900 is loaded by a liquid loading device 100 containing pure DMSO solvent. Then each of the solutions is loaded onto a separate surface-patterned substrate 900 using the loading loading device 100 shown in FIG. 3B. Each surface-patterned substrate 900 with salts mixtures is sequentially sandwiched onto the first surface-patterned substrate 900 containing pure DMSO. This resulting surface-patterned substrate 900 is left for drying while being imaged under a microscope. FIG. 23B shows the crystals formed from 620 different combinations of A site and X site substitutions.

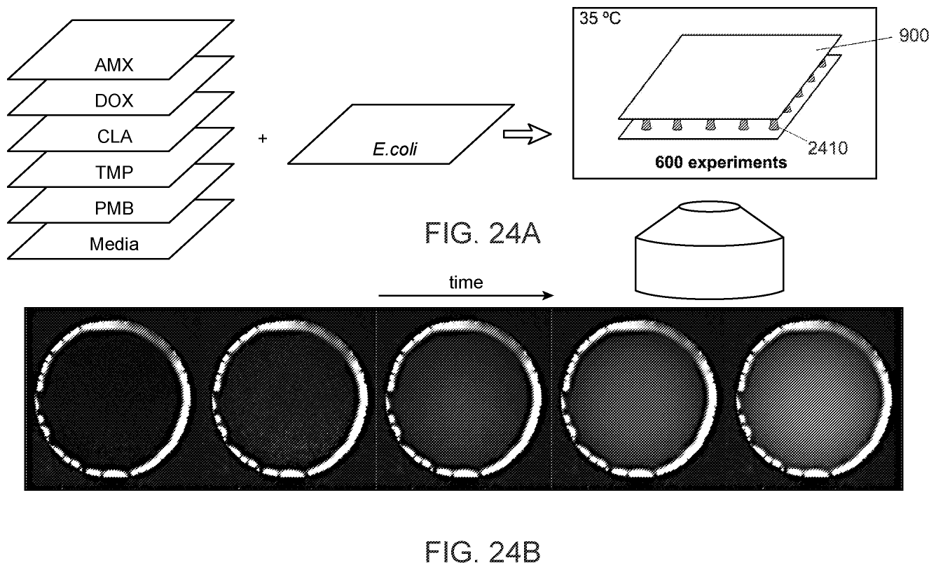

FIGS. 24A and 24B depict an example application of a liquid dispensing system 1000 related to testing antibiotic combinations, in accordance with certain examples. FIG. 24A depicts five separate surface-patterned substrates 900 loaded using a liquid loading device 100 with antibiotic mixtures of different volumes to the patterned first regions 910. Each of the five surface-patterned substrates 900 contains a different antibiotic and are all mixed into a surface-patterned substrate 900 containing a liquid growth media. The surface-patterned substrate 900 containing media and different concentrations of each of the five antibiotics are combined with a surface-patterned substrate 900 containing E. coli W3110 cells to result in 600 individual experiments, each isolated in capillary bridges 2410. The two surface-patterned substrates 900 are sealed and incubated at 35° C. and continuously imaged under dark-field microscopy for 24 hours. FIG. 24B depicts cell growth in merged liquid 2410 confined by two facing first regions on the imaged surface-patterned substrate 900 over a period of 24 hours. Each of the white rings depicts the edge merged liquid 2410 and an increase of white intensity inside this ring indicates cell growth.

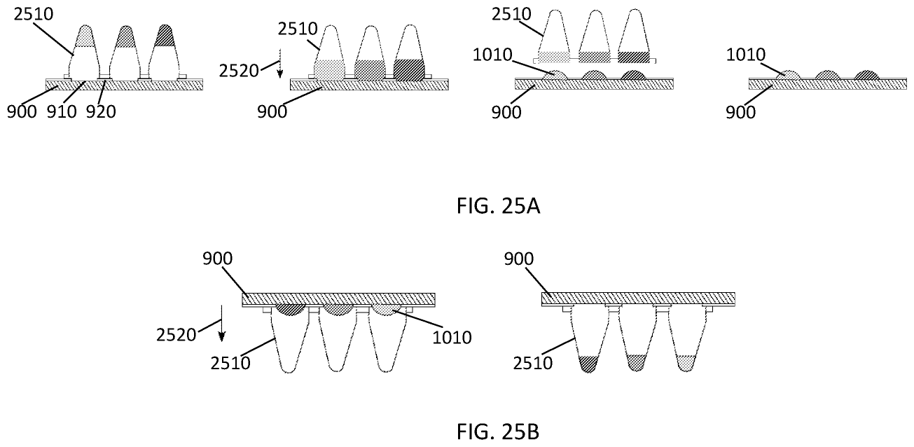

FIGS. 25A and 25B depict transfer of liquids from a set of wells 2510 to surface-patterned substrate 900 and from surface-patterned substrate 900 to a set of wells 2510, in accordance with certain examples. FIG. 25A depicts a transfer sequence where the set of wells 2510 are situated above surface-patterned substrate 900, then an acceleration is applied to drive liquid down in the direction indicated by arrow 2520 to contact surface-patterned substrate 900. The set of wells 2510 is then removed from surface-patterned substrate 900 leaving liquid mixtures 1010 deposited on surface-patterned substrate 900. FIG. 25B depicts transfer of liquid mixtures 1010 from surface-patterned substrate 900 in the direction indicated by arrow 2520 to the set of wells 2510 by means of acceleration.

The systems, methods, and acts described in the examples presented previously are illustrative, and, alternatively, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment,” “an embodiment,” “an example embodiment,” or other similar language means that a particular feature, structure, or characteristic described in connection with the embodiment is included in at least one embodiment of the invention described herein. Thus, appearances of the phrases “in one embodiment,” “in an embodiment,” “an example embodiment,” or other similar language in various places throughout this specification are not necessarily all referring to the same embodiment. Furthermore, the particular features, structures, or characteristics may be combined in any suitable manner in one or more embodiments, as would be apparent to a person having ordinary skill in the art and the benefit of this disclosure. Furthermore, while some embodiments described herein include some, but not other, features included in other embodiments, combinations of features of different embodiments are meant to be within the scope of the invention. For example, in the appended claims, any of the claimed embodiments can be used in any combination.

Example 1 is a system, comprising: a loading device; and a substrate, the loading device configured to deposit one or more liquid(s) on the substrate and to confine the one or more liquid(s) within the loading device, the loading device comprising: a liquid confinement area comprising at least one opening in a bottom layer of the loading device configured to hold the one or more liquid(s) and to transfer the one or more liquid(s) to the substrate, and a calibration mechanism that provides calibration of movement relative to the substrate; and the substrate comprising: a plurality of a first region having a first contact angle with the one or more liquid(s) in the loading device, and one or more second region(s) located to surround the plurality of the first region and having a second contact angle with the one or more liquid(s) in the loading device, wherein the system is configured to transfer the one or more liquid(s) from the loading device to one or more of the pluralit(ies) of the first region of the substrate.

Example 2 includes the subject matter of Example 1, the system configured to control a volume of the one or more liquid(s) transferred to each of the one or more of the pluralit(ies) of the first region of the substrate.

Example 3 includes the subject matter of Example 1 or Example 2, the loading device configured to move across a top surface of the substrate to transfer the one or more liquid(s) from the loading device to one or more of the pluralit(ies) of the first region of the substrate.

Example 4 includes the subject matter of any of Examples 1-3, the calibration mechanism configured to adjust a path of the movement of the loading device.

Example 5 includes the subject matter of any of Examples 1-4, the at least one opening comprising a position above one or more of the pluralit(ies) of the first region of the substrate.

Example 6 includes the subject matter of any of Examples 1-5, the movement comprising one or more direction(s).

Example 7 includes the subject matter of any of Examples 1-6, further comprising a frame to constrain the orientation of the loading device relative to the substrate in at least one direction.

Example 8 includes the subject matter of any of Examples 1-7, further comprising a gap between the bottom layer of the loading device and the substrate.

Example 9 includes the subject matter of any of Examples 1-8, the gap comprising a distance between the bottom layer of the loading device and the substrate less than the capillary length of the one or more liquids.

Example 10 includes the subject matter of any of Examples 1-9, the gap comprising a substantially uniform distance between the bottom layer of the loading device and the substrate.

Example 11 includes the subject matter of any of Examples 1-10, the gap comprising a non-uniform distance between the bottom layer of the loading device and the substrate.

Example 12 includes the subject matter of any of Examples 1-11, further comprising spacer elements affixable to the loading device or the substrate to form the gap.

Example 13 includes the subject matter of any of Examples 1-12, further comprising an external structure or surface to form the gap.

Example 14 includes the subject matter of any of Examples 1-13, the liquid confinement area comprising an elongated configuration.

Example 15 includes the subject matter of any of Examples 1-14, the liquid confinement area comprising one or more confinement section(s).

Example 16 includes the subject matter of any of Examples 1-15, the at least one opening comprising a rectangular, square, circular, trapezoidal, oval, or polygonal cross section.

Example 17 includes the subject matter of any of Examples 1-16, the loading device further comprising one or more geometrical pinning structure(s) on the bottom layer of the loading device configured to confine the one or more liquid(s) and to transfer the one or more liquid(s) to the substrate.

Example 18 includes the subject matter of any of Examples 1-17, wherein one or more surface(s) of the one or more geometrical pinning structure(s) comprise a coating.

Example 19 includes the subject matter of any of Examples 1-18, the coating comprising a hydrophobic, omniphobic, oleophobic, superhydrophobic, superomniphobic, or superoleophobic coating.

Example 20 includes the subject matter of any of Examples 1-19, the loading device comprising a coating on a face of the loading device proximal to the substrate, the coating spatially confining the one or more liquid(s) within the loading device.

Example 21 includes the subject matter of any of Examples 1-20, the coating comprising a hydrophobic, omniphobic, oleophobic, superhydrophobic, superomniphobic, or superoleophobic coating.

Example 22 includes the subject matter of any of Examples 1-21, the calibration mechanism comprising a polymer, glass, metal, wood, or any combination thereof.

Example 23 includes the subject matter of any of Examples 1-22, further comprising a liquid holding element, the liquid holding element comprising at least one opening in a bottom layer of the liquid holding element and configured to hold the one or more liquid(s) and to transfer the one or more liquid(s) to the substrate.

Example 24 includes the subject matter of any of Examples 1-23, the liquid holding element comprising a rectangular, square, circle, trapezoidal, or polygonal cross section.

Example 25 includes the subject matter of any of Examples 1-24, the liquid holding element comprising a coating on a face of the liquid holding element proximal to the substrate, the coating spatially confining the one or more liquid(s) within the liquid holding element.

Example 26 includes the subject matter of any of Examples 1-25, the coating comprising a hydrophobic, omniphobic, oleophobic, superhydrophobic, superomniphobic, or superoleophobic coating.

Example 27 includes the subject matter of any of Examples 1-26, the liquid holding element comprising one or more interchangeable distribution block(s), the one or more interchangeable distribution block(s) arranged to provide at the at least one opening in the bottom layer of the liquid holding element.

Example 28 includes the subject matter of any of Examples 1-27, each block of the one or more interchangeable distribution block(s) comprising zero or more openings to hold the one or more liquid(s).

Example 29 includes the subject matter of any of Examples 1-28, the liquid holding element comprising a polymer, glass, metal, or any combination thereof.

Example 30 includes the subject matter of any of Examples 1-29, the calibration mechanism comprising a housing configured to secure the liquid holding element in the loading device.

Example 31 includes the subject matter of any of Examples 1-30, the housing comprising two or more symmetrical structures to mate with two or more grooves on the liquid holding element.

Example 32 includes the subject matter of any of Examples 1-31, the housing comprising two or more grooves to mate with two or more symmetrical structures on the liquid holding element.

Example 33 includes the subject matter of any of Examples 1-32, the one or more liquid(s) being spatially confined by a coating on a face of the loading device proximal to the substrate.

Example 34 includes the subject matter of any of Examples 1-33, the coating comprising a hydrophobic, omniphobic, oleophobic, superhydrophobic, superomniphobic, or superoleophobic coating.

Example 35 includes the subject matter of any of Examples 1-34, wherein the one or more liquid(s) are confined in through-holes.

Example 36 includes the subject matter of any of Examples 1-35, wherein the through-holes are straight.

Example 37 includes the subject matter of any of Examples 1-36, wherein the through-holes are tapered.

Example 38 includes the subject matter of any of Examples 1-37, wherein walls of the through-holes comprise a coating such that the one or more liquid(s) move freely through the through-holes.

Example 39 includes the subject matter of any of Examples 1-38, the coating comprising a hydrophobic, omniphobic, oleophobic, superhydrophobic, superomniphobic, or superoleophobic coating.

Example 40 includes the subject matter of any of Examples 1-39, the coating comprising a low sliding angle.

Example 41 includes the subject matter of any of Examples 1-40, where the one or more liquid(s) are confined in indentations.

Example 42 includes the subject matter of any of Examples 1-41, wherein the indentations comprise a coating such that the one or more liquid(s) move freely through the indentations.

Example 43 includes the subject matter of any of Examples 1-42, the coating comprising a hydrophobic, omniphobic, oleophobic, superhydrophobic, superomniphobic, or superoleophobic coating.

Example 44 includes the subject matter of any of Examples 1-43, the coating comprising a low sliding angle.

Example 45 includes the subject matter of any of Examples 1-44, wherein the one or more liquid(s) are confined on a substantially planar surface.

Example 46 includes the subject matter of any of Examples 1-45, the loading device comprising a metal, glass, ceramic, or polymer.

Example 47 includes the subject matter of any of Examples 1-46, the loading device manufactured by 3D printing, milling, molding, thermoforming, machining, cutting, punching, forming, shearing, stamping, or lithographically printing.

Example 48 includes the subject matter of any of Examples 1-47, wherein the plurality of the first region and the one or more second region(s) are in a same plane as a top surface of the substrate.

Example 49 includes the subject matter of any of Examples 1-48, wherein the one or more second region(s) are in a same plane as a top surface of the substrate and the plurality of the first region are disposed in a lower position relative to the one or more second region(s).

Example 50 includes the subject matter of any of Examples 1-49, wherein the plurality of the first region are wells with a depth of 0 to 3 mm relative to the top surface of the substrate.

Example 51 includes the subject matter of any of Examples 1-50, wherein the plurality of the first region comprises a hydrophilic, oleophilic, or omniphilic coating.

Example 52 includes the subject matter of any of Examples 1-51, wherein the plurality of the first region comprises a high surface energy coating.

Example 53 includes the subject matter of any of Examples 1-52, wherein the one or more second region(s) comprise a hydrophobic, omniphobic, oleophobic, superhydrophobic, superomniphobic, or superoleophobic coating.

Example 54 includes the subject matter of any of Examples 1-53, wherein the one or more second region(s) comprise a low surface energy coating.

Example 55 includes the subject matter of any of Examples 1-54, wherein the first contact angle is less than or equal to 90°.

Example 56 includes the subject matter of any of Examples 1-55, wherein the second contact angle is greater than or equal to 150°.

Example 57 includes the subject matter of any of Examples 1-56, wherein the first contact angle of the first region is less than the second contact angle of the second region.

Example 58 includes the subject matter of any of Examples 1-57, wherein the plurality of the first region comprises a shape of a circle, rectangle, square, trapezoid, oval, polygon, or any combination thereof.

Example 59 is a loading device configured to deposit one or more liquid(s) on a substrate and to confine the one or more liquid(s) within the loading device, the loading device comprising: a liquid confinement area comprising at least one opening in a bottom layer of the loading device configured to hold the one or more liquid(s) and to transfer the one or more liquid(s) to the substrate; and a calibration mechanism that provides calibration of movement along the substrate, wherein the loading device is configured to transfer the one or more liquid(s) to the substrate.

Example 60 includes the subject matter of Example 59, further comprising one or more geometrical pinning structure(s) on the bottom layer of the loading device configured to confine the one or more liquid(s) and to transfer the one or more liquid(s) to the substrate.

Example 61 includes the subject matter of Examples 59 and 60, wherein one or more surface(s) of the one or more geometrical pinning structure(s) comprise a coating.

Example 62 includes the subject matter of any of Examples 59-61, the coating comprising a hydrophobic, omniphobic, oleophobic, superhydrophobic, superomniphobic, or superoleophobic coating.

Example 63 includes the subject matter of any of Examples 59-62, the liquid confinement area comprising an elongated configuration.

Example 64 includes the subject matter of any of Examples 59-63, the liquid confinement area comprising one or more confinement section(s).

Example 65 includes the subject matter of any of Examples 59-64, the at least one opening comprising a rectangular, square, circular, trapezoidal, oval, or polygonal cross section.

Example 66 includes the subject matter of any of Examples 59-65, the loading device comprising a coating on a face of the loading device proximal to the substrate, the coating spatially confining the one or more liquid(s) within the loading device.

Example 67 includes the subject matter of any of Examples 59-66, the coating comprising a hydrophobic, omniphobic, oleophobic, superhydrophobic, superomniphobic, or superoleophobic coating.

Example 68 includes the subject matter of any of Examples 59-67, the calibration mechanism comprising a polymer, glass, metal, wood, or any combination thereof.

Example 69 includes the subject matter of any of Examples 59-68, further comprising a liquid holding element, the liquid holding element comprising at least one opening in a bottom layer of the liquid holding element and configured to hold the one or more liquid(s) and to transfer the one or more liquid(s) to the substrate.

Example 70 includes the subject matter of any of Examples 59-69, the liquid holding element comprising a rectangular, square, circle, trapezoidal, or polygonal cross section.

Example 71 includes the subject matter of any of Examples 59-70, the liquid holding element comprising a coating on a face of the liquid holding element proximal to the substrate, the coating spatially confining the one or more liquid(s) within the liquid holding element.

Example 72 includes the subject matter of any of Examples 59-71, the coating comprising a hydrophobic, omniphobic, oleophobic, superhydrophobic, superomniphobic, or superoleophobic coating.

Example 73 includes the subject matter of any of Examples 59-72, the liquid holding element comprising one or more interchangeable distribution block(s), the one or more interchangeable distribution block(s) arranged to provide at the at least one opening in the bottom layer of the liquid holding element.

Example 74 includes the subject matter of any of Examples 59-73, each block of the one or more interchangeable distribution block(s) comprising zero or more openings to hold the one or more liquid(s).

Example 75 includes the subject matter of any of Examples 59-74, the liquid holding element comprising a polymer, glass, metal, or any combination thereof.

Example 76 includes the subject matter of any of Examples 59-75, the calibration mechanism comprising a housing configured to secure the liquid holding element in the loading device.

Example 77 includes the subject matter of any of Examples 59-76, the housing comprising two or more symmetrical structures to mate with two or more grooves on the liquid holding element.

Example 78 includes the subject matter of any of Examples 59-77, the housing comprising two or more grooves to mate with two or more symmetrical structures on the liquid holding element.

Example 79 includes the subject matter of any of Examples 59-78, the one or more liquid(s) being spatially confined by a coating on a face of the loading device proximal to the substrate.

Example 80 includes the subject matter of any of Examples 59-79, the coating comprising a hydrophobic, omniphobic, oleophobic, superhydrophobic, superomniphobic, or superoleophobic coating.

Example 81 includes the subject matter of any of Examples 59-80, wherein the one or more liquid(s) are confined in through-holes.

Example 82 includes the subject matter of any of Examples 59-81, wherein the through-holes are straight.

Example 83 includes the subject matter of any of Examples 59-82, wherein the through-holes are tapered.

Example 84 includes the subject matter of any of Examples 59-83, wherein walls of the through-holes comprising a coating such that the one or more liquid(s) move freely through the through-holes.

Example 85 includes the subject matter of any of Examples 59-84, the coating comprising a hydrophobic, omniphobic, oleophobic, superhydrophobic, superomniphobic, or superoleophobic coating.

Example 86 includes the subject matter of any of Examples 59-85, the coating comprising a low sliding angle.

Example 87 includes the subject matter of any of Examples 59-86, where the one or more liquid(s) are confined in indentations.

Example 88 includes the subject matter of any of Examples 59-87, wherein the indentations comprise a coating such that the one or more liquid(s) move freely through the through-holes.

Example 89 includes the subject matter of any of Examples 59-88, the coating comprising a hydrophobic, omniphobic, oleophobic, superhydrophobic, superomniphobic, or superoleophobic coating.

Example 90 includes the subject matter of any of Examples 59-89, the coating comprising a low sliding angle.

Example 91 includes the subject matter of any of Examples 59-90, wherein the one or more liquid(s) are confined on a substantially planar surface.

Example 92 includes the subject matter of any of Examples 59-91, the loading device comprising a metal, glass, ceramic, or polymer.

Example 93 includes the subject matter of any of Examples 59-92, the loading device manufactured by 3D printing, milling, molding, thermoforming, machining, cutting, punching, forming, shearing, stamping, or lithographically printing.

Example 94 is a substrate, comprising: a plurality of a first region wherein the plurality of the first region has a first contact angle with one or more liquid(s) in a loading device; and one or more second region(s) located to surround the plurality of the first region and wherein the one or more second region(s) have a second contact angle with the one or more liquid(s) in the loading device, wherein the substrate is configured to receive the one or more liquid(s) from the loading device such that the one or more liquid(s) are confined to one or more of the pluralit(ies) of the first region of the substrate.

Example 95 includes the subject matter of Example 94, wherein the plurality of the first region and the one or more second region(s) are in a same plane as a top surface of the substrate.

Example 96 includes the subject matter of Examples 94 and 95, wherein the one or more second region(s) are in a same plane as a top surface of the substrate and the plurality of the first region are disposed in a lower position relative to the one or more second region(s).

Example 97 includes the subject matter of any of Examples 94-96, wherein the plurality of the first region are wells with a depth of 0 to 3 mm relative to the top surface of the substrate.

Example 98 includes the subject matter of any of Examples 94-97, wherein the plurality of the first region comprises a hydrophilic, oleophilic, or omniphilic coating.

Example 99 includes the subject matter of any of Examples 94-98, wherein the plurality of the first region comprises a high surface energy coating.

Example 100 includes the subject matter of any of Examples 94-99, wherein the one or more second region(s) comprise a hydrophobic, omniphobic, oleophobic, superhydrophobic, superomniphobic, or superoleophobic coating.

Example 101 includes the subject matter of any of Examples 94-100, wherein the one or more second region(s) comprise a low surface energy coating.

Example 102 includes the subject matter of any of Examples 94-101, wherein the first contact angle is less than or equal to 90°.

Example 103 includes the subject matter of any of Examples 94-102, wherein the second contact angle is greater than or equal to 150°.

Example 104 includes the subject matter of any of Examples 94-103, wherein the plurality of the first region comprises a shape of a circle, rectangle, square, trapezoid, oval, polygon, or any combination thereof.

Example 105 includes the subject matter of any of Examples 94-104, configured to transfer one or more liquid(s) to a receiving vessel or set of receiving vessels.

Example 106 includes the subject matter of any of Examples 94-105, wherein the receiving vessel or set of receiving vessels is a second substrate.

Example 107 includes the subject matter of any of Examples 94-106, wherein the receiving vessel or set of receiving vessels comprises one or more wells.

Example 108 includes the subject matter of any of Examples 94-107, wherein the substrate is configured to transfer the one or more liquid(s) to the receiving vessel or set of receiving vessels by acceleration or pressure.

Example 109 includes the subject matter of any of Examples 94-108, wherein the substrate is configured to transfer liquid to the second substrate by direct contact between the one or more liquid(s) on the substrate and one or more liquid(s) on the second substrate.

Example 110 includes the subject matter of any of Examples 94-109, wherein the substrate is configured to transfer liquid to the second substrate by direct contact between the one or more liquid(s) and the second substrate.

Example 111 includes the subject matter of any of Examples 94-110, configured to receive one or more liquid(s) from a vessel or set of vessels.

Example 112 includes the subject matter of any of Examples 94-111, wherein the vessel or set of vessels is a second substrate.

Example 113 includes the subject matter of any of Examples 94-112, wherein the vessel or set of vessels comprises one or more wells.

Example 114 includes the subject matter of any of Examples 94-113, wherein the substrate is configured to receive from the vessel or set of vessels by acceleration or pressure.

Example 115 includes the subject matter of any of Examples 94-114, wherein the substrate is configured to receive liquid from the second substrate by direct contact between one or more liquid(s) on the second substrate and the one or more liquid(s).

Example 116 is a method to deposit liquids on a substrate, the method comprising: positioning the loading device of any of claims 56 through 87 a distance above the substrate of any of claims 88 through 98; inserting one or more liquid(s) into the loading device; and traversing the loading device at the distance above the substrate across the substrate in one or more directions.

Example 117 is a system, comprising a loading device comprising at least one liquid reservoir, the at least one liquid reservoir defining an opening at a bottom portion of the at least one liquid reservoir to discharge a liquid borne by the at least one reservoir; a substrate holder, at least one of the loading device and/or the substrate holder being movably disposed relative to one another, the substrate holder comprising a substrate receiving area to removably receive a removable substrate, disposed adjacent to the loading device to dispose the substrate receiving area of the substrate holder adjacent the opening at the bottom portion of the at least one liquid reservoir over at least a portion of a range of movement of the loading device relative to the substrate holder; and one or more registration members provided on the loading device, the substrate holder, or both the loading device and the substrate holder to maintain a spacing between the opening at the bottom portion of the at least one liquid reservoir and an upper surface of a substrate borne within the substrate receiving at a predetermined spacing or within a range of predetermined spacings over at least a portion of a range of movement of the loading device relative to the substrate holder, wherein the predetermined spacing or and/or the range of predetermined spacings are selected to maintain a gap having a first height between a bottom surface of a droplet formed at the opening at the bottom portion of the at least one liquid reservoir and an upper surface of a substrate borne within the substrate over at least a portion of a range of movement of the loading device relative to the substrate holder.

Example 118 is the system according to Example 117, wherein a height of the at least one liquid reservoir and an area of the opening defined at the bottom portion of the at least one liquid reservoir is dimensioned to form a droplet of a liquid borne by the at least one liquid reservoir having a first contact angle within a predetermined range of contact angles.

Example 119 is the system according to Example 117 or Example 118, wherein the first height of the gap is less than a capillary length of a liquid borne by the at least one liquid reservoir.

Example 120 is the system according to any one of Examples 117 to 119, wherein the loading device comprises a plurality of liquid reservoirs, each of the plurality of liquid reservoirs defining an opening at a bottom portion of the respective liquid reservoir to selectively discharge a liquid borne therein to a substrate borne by the substrate holder.

Example 121 is the system according to any one of Examples 117 to 120, further comprising a substrate dimensioned for removable placement within the substrate receiving area, the substrate comprising a first end at a first portion of the range of movement of the loading device relative to the substrate holder and the substrate borne therein and a second end at a second portion of the range of movement of the loading device relative to the substrate holder, the substrate further comprising at least one liquid confinement portion comprising a liquid receiving area in, on, or through the substrate.

Example 122 is the system according to any one of Examples 117 to 121, wherein the substrate comprises a plurality of liquid confinement portions.

Example 123 is the system according to any one of Examples 117 to 122, wherein the substrate comprises an array of the plurality of liquid confinement portions.

Example 124 is the system according to any one of Examples 117 to 123, wherein the array of the plurality of liquid confinement portions comprises a n×m or a n×n array, wherein n or m can be any integer.

Example 125 is the system according to any one of Examples 117 to 124, wherein the loading device and the substrate holder are movable relative to one another along one axis.

Example 126 is the system according to any one of Examples 117 to 125, wherein the loading device and the substrate holder are translatable relative to one another.

Example 127 is the system according to any one of Examples 117 to 126, wherein one of the loading device or the substrate holder is stationary and the other one of the loading device or the substrate holder is translatable relative to the other one of the loading device or the substrate holder.

Example 128 is the system according to any one of Examples 117 to 127, wherein one of the loading device or the substrate holder is stationary and the other one of the loading device or the substrate holder is rotatable relative to the other one of the loading device or the substrate holder.

Example 129 is the system according to any one of Examples 117 to 128, wherein the loading device and the substrate holder are movable relative to one another along a plurality of axes.

Example 130 is the system according to any one of Examples 117 to 129, wherein the plurality of liquid reservoirs are disposed in an array across at least a portion of the loading device.

Example 131 is the system according to any one of Examples 117 to 130, wherein the array of the plurality of liquid reservoirs comprises a n×m or a n×n array, wherein n or m can be any integer.

Example 132 is the system according to any one of Examples 117 to 131, wherein an upper surface of the substrate outside the liquid receiving areas comprises a hydrophobic, omniphobic, oleophobic, superhydrophobic, superomniphobic, or superoleophobic coating.

Example 133 is the system according to any one of Examples 117 to 132, wherein the liquid confinement portion(s) comprise a hydrophilic, oleophilic, or omniphilic coating.

Example 134 is the system according to any one of Examples 117 to 133, wherein an upper surface of the substrate comprises a first coating and the liquid confinement portion(s) comprise a second coating different than the first coating.

What is claimed is:

1. A system, comprising:
a loading device; and
a substrate,
the loading device configured to deposit one or more liquid(s) on the substrate and to confine the one or more liquid(s) within the loading device, the loading device comprising:
a liquid confinement area comprising at least one opening in a bottom layer of the loading device configured to hold the one or more liquid(s) and to transfer the one or more liquid(s) to the substrate, and
a calibration mechanism that provides calibration of movement relative to the substrate; and
the substrate comprising:
a plurality of a first region having a first contact angle with the one or more liquid(s) in the loading device, and
one or more second region(s) located to surround the plurality of the first region and having a second contact angle with the one or more liquid(s) in the loading device,
wherein the system is configured to transfer the one or more liquid(s) from the loading device to one or more of the pluralit(ies) of the first region of the substrate.

2. The system of claim 1, the system configured to control a volume of the one or more liquid(s) transferred to each of the one or more of the pluralit(ies) of the first region of the substrate.

3. The system of claim 1, the loading device configured to move across a top surface of the substrate to transfer the one or more liquid(s) from the loading device to one or more of the pluralit(ies) of the first region of the substrate.

4. The system of claim 3, the calibration mechanism configured to adjust a path of the movement of the loading device.

5. The system of claim 1, the at least one opening comprising a position above one or more of the pluralit(ies) of the first region of the substrate.

6. The system of claim 1, the movement comprising one or more direction(s).

7. The system of claim 1, further comprising a frame to constrain the orientation of the loading device relative to the substrate in at least one direction.

8. The system of claim 1, further comprising a gap between the bottom layer of the loading device and the substrate.

9. The system of claim 8, the gap comprising a distance between the bottom layer of the loading device and the substrate less than the capillary length of the one or more liquids.

10. The system of claim 8, the gap comprising a substantially uniform distance between the bottom layer of the loading device and the substrate.

11. The system of claim 8, the gap comprising a non-uniform distance between the bottom layer of the loading device and the substrate.

12. The system of claim 8, further comprising spacer elements affixable to the loading device or the substrate to form the gap.

13. The system of claim 8, further comprising an external structure or surface to form the gap.

14. The system of claim 1, the liquid confinement area comprising an elongated configuration.

15. The system of claim 1, the liquid confinement area comprising one or more confinement section(s).

16. The system of claim 1, the at least one opening comprising a rectangular, square, circular, trapezoidal, oval, or polygonal cross section.

17. The system of claim 1, the loading device further comprising one or more geometrical pinning structure(s) on the bottom layer of the loading device configured to confine the one or more liquid(s) and to transfer the one or more liquid(s) to the substrate.

18. The system of claim 17, wherein one or more surface(s) of the one or more geometrical pinning structure(s) comprise a coating.

19. The system of claim 18, the coating comprising a hydrophobic, omniphobic, oleophobic, superhydrophobic, superomniphobic, or superoleophobic coating.

20. The system of claim 1, the loading device comprising a coating on a face of the loading device proximal to the substrate, the coating spatially confining the one or more liquid(s) within the loading device.

21. The system of claim 20, the coating comprising a hydrophobic, omniphobic, oleophobic, superhydrophobic, superomniphobic, or superoleophobic coating.

22. The system of claim 1, the calibration mechanism comprising a polymer, glass, metal, wood, or any combination thereof.

23. The system of claim 1, further comprising a liquid holding element, the liquid holding element comprising at least one opening in a bottom layer of the liquid holding element and configured to hold the one or more liquid(s) and to transfer the one or more liquid(s) to the substrate.

24. The system of claim 23, the liquid holding element comprising a rectangular, square, circle, trapezoidal, or polygonal cross section.

25. The system of claim 23, the liquid holding element comprising a coating on a face of the liquid holding element proximal to the substrate, the coating spatially confining the one or more liquid(s) within the liquid holding element.

26. The system of claim 25, the coating comprising a hydrophobic, omniphobic, oleophobic, superhydrophobic, superomniphobic, or superoleophobic coating.

27. The system of claim 23, the liquid holding element comprising one or more interchangeable distribution block(s), the one or more interchangeable distribution block(s) arranged to provide at the at least one opening in the bottom layer of the liquid holding element.

28. The system of claim 27, each block of the one or more interchangeable distribution block(s) comprising zero or more openings to hold the one or more liquid(s).

29. The system of claim 23, the liquid holding element comprising a polymer, glass, metal, or any combination thereof.

30. The system of claim 23, the calibration mechanism comprising a housing configured to secure the liquid holding element in the loading device.

31. The system of claim 30, the housing comprising two or more symmetrical structures to mate with two or more grooves on the liquid holding element.

32. The system of claim 30, the housing comprising two or more grooves to mate with two or more symmetrical structures on the liquid holding element.

33. The system of claim 1, the one or more liquid(s) being spatially confined by a coating on a face of the loading device proximal to the substrate.

34. The system of claim 33, the coating comprising a hydrophobic, omniphobic, oleophobic, superhydrophobic, superomniphobic, or superoleophobic coating.

35. The system of claim 1, wherein the one or more liquid(s) are confined in through-holes.

36. The system of claim 35, wherein the through-holes are straight.

37. The system of claim 35, wherein the through-holes are tapered.

38. The system of claim 35, wherein walls of the through-holes comprise a coating such that the one or more liquid(s) move freely through the through-holes.

39. The system of claim 38, the coating comprising a hydrophobic, omniphobic, oleophobic, superhydrophobic, superomniphobic, or superoleophobic coating.

40. The system of claim 38, the coating comprising a low sliding angle.

41. The system of claim 1, wherein the one or more liquid(s) are confined in indentations.

42. The system of claim 41, the indentations comprising a coating such that the one or more liquid(s) move freely through the indentations.

43. The system of claim 42, the coating comprising a hydrophobic, omniphobic, oleophobic, superhydrophobic, superomniphobic, or superoleophobic coating. The system of claim 42, the coating comprising a low sliding angle.

45. The system of claim 1, wherein the one or more liquid(s) are confined on a substantially planar surface.

46. The system of claim 1, the loading device comprising a metal, glass, ceramic, or polymer.

47. The system of claim 1, the loading device manufactured by 3D printing, milling, molding, thermoforming, machining, cutting, punching, forming, shearing, stamping, or lithographically printing.

48. The system of claim 1, wherein the plurality of the first region and the one or more second region(s) are in a same plane as a top surface of the substrate.

49. The system of claim 1, wherein the one or more second region(s) are in a same plane as a top surface of the substrate and the plurality of the first region are disposed in a lower position relative to the one or more second region(s).

50. The system of claim 49, wherein the plurality of the first region are wells with a depth of 0 to 3 mm relative to the top surface of the substrate.

51. The system of claim 1, wherein the plurality of the first region comprises a hydrophilic, oleophilic, or omniphilic coating.

52. The system of claim 1, wherein the plurality of the first region comprises a high surface energy coating.

53. The system of claim 1, wherein the one or more second region(s) comprise a hydrophobic, oleophobic, omniphobic, or superomniphobic coating.

54. The system of claim 1, wherein the one or more second region(s) comprise a low surface energy coating.

55. The system of claim 1, wherein the first contact angle is less than or equal to 90°. 56. The system of claim 1, wherein the second contact angle is greater than or equal to 150°. 57. The system of claim 1, wherein the first contact angle of the first region is less than the second contact angle of the second region.

58. The system of claim 1, wherein the plurality of the first region comprises a shape of a circle, rectangle, square, trapezoid, oval, polygon, or any combination thereof.

59. A loading device configured to deposit one or more liquid(s) on a substrate and to confine the one or more liquid(s) within the loading device, the loading device comprising:
a liquid confinement area comprising at least one opening in a bottom layer of the loading device configured to hold the one or more liquid(s) and to transfer the one or more liquid(s) to the substrate; and
a calibration mechanism that provides calibration of movement along the substrate, wherein the loading device is configured to transfer the one or more liquid(s) to the substrate.

60. The loading device of claim 59, further comprising one or more geometrical pinning structure(s) on the bottom layer of the loading device configured to confine the one or more liquid(s) and to transfer the one or more liquid(s) to the substrate.

61. The loading device of claim 60, wherein one or more surface(s) of the one or more geometrical pinning structure(s) comprise a coating.

62. The loading device of claim 61, the coating comprising a hydrophobic, omniphobic, oleophobic, superhydrophobic, superomniphobic, or superoleophobic coating.

63. The loading device of claim 59, the liquid confinement area comprising an elongated configuration.

64. The loading device of claim 59, the liquid confinement area comprising one or more confinement section(s).

65. The loading device of claim 59, the at least one opening comprising a rectangular, square, circular, trapezoidal, oval, or polygonal cross section.

66. The loading device of claim 59, the loading device comprising a coating on a face of the loading device proximal to the substrate, the coating spatially confining the one or more liquid(s) within the loading device.

67. The loading device of claim 66, the coating comprising a hydrophobic, omniphobic, oleophobic, superhydrophobic, superomniphobic, or superoleophobic coating.

68. The loading device of claim 59, the calibration mechanism comprising a polymer, glass, metal, wood, or any combination thereof.

69. The loading device of claim 59, further comprising a liquid holding element, the liquid holding element comprising at least one opening in a bottom layer of the liquid holding element and configured to hold the one or more liquid(s) and to transfer the one or more liquid(s) to the substrate.

70. The loading device of claim 69, the liquid holding element comprising a rectangular, square, circle, trapezoidal, or polygonal cross section.

71. The loading device of claim 69, the liquid holding element comprising a coating on a face of the liquid holding element proximal to the substrate, the coating spatially confining the one or more liquid(s) within the liquid holding element.

72. The loading device of claim 71, the coating comprising a hydrophobic, omniphobic, oleophobic, superhydrophobic, superomniphobic, or superoleophobic coating.

73. The loading device of claim 69, the liquid holding element comprising one or more interchangeable distribution block(s), the one or more interchangeable distribution block(s) arranged to provide at the at least one opening in the bottom layer of the liquid holding element.

74. The loading device of claim 73, each block of the one or more interchangeable distribution block(s) comprising zero or more openings to hold the one or more liquid(s).

75. The loading device of claim 69, the liquid holding element comprising a polymer, glass, metal, or any combination thereof.

76. The loading device of claim 69, the calibration mechanism comprising a housing configured to secure the liquid holding element in the loading device.

77. The loading device of claim 76, the housing comprising two or more symmetrical structures to mate with two or more grooves on the liquid holding element.

78. The loading device of claim 76, the housing comprising two or more grooves to mate with two or more symmetrical structures on the liquid holding element.

79. The loading device of claim 59, the one or more liquid(s) being spatially confined by a coating on a face of the loading device proximal to the substrate.

80. The loading device of claim 79, the coating comprising a hydrophobic, omniphobic, oleophobic, superhydrophobic, superomniphobic, or superoleophobic coating.

81. The loading device of claim 59, wherein the one or more liquid(s) are confined in through-holes.

82. The loading device of claim 81, wherein the through-holes are straight.

83. The loading device of claim 81, wherein the through-holes are tapered.

84. The loading device of claim 81, wherein walls of the through-holes comprise a coating such that the one or more liquid(s) move freely through the through-holes.

85. The loading device of claim 84, the coating comprising a hydrophobic, omniphobic, oleophobic, superhydrophobic, superomniphobic, or superoleophobic coating.

86. The loading device of claim 84, the coating comprising a low sliding angle.

87. The loading device of claim 59, where the one or more liquid(s) are confined in indentations.

88. The loading device of claim 87, wherein the indentations comprise a coating such that the one or more liquid(s) move freely through the through-holes.

89. The loading device of claim 88, the coating comprising a hydrophobic, omniphobic, oleophobic, superhydrophobic, superomniphobic, or superoleophobic coating.

90. The loading device of claim 88, the coating comprising a low sliding angle.

91. The loading device of claim 59, wherein the one or more liquid(s) are confined on a substantially planar surface.

92. The loading device of claim 59, the loading device comprising a metal, glass, ceramic, or polymer.

93. The loading device of claim 59, the loading device manufactured by 3D printing, milling, molding, thermoforming, machining, cutting, punching, forming, shearing, stamping, or lithographically printing.

94. A substrate, comprising:
a plurality of a first region wherein the plurality of the first region has a first contact angle with one or more liquid(s) in a loading device; and
one or more second region(s) located to surround the plurality of the first region and wherein the one or more second region(s) have a second contact angle with the one or more liquid(s) in the loading device,
wherein the substrate is configured to receive the one or more liquid(s) from the loading device such that the one or more liquid(s) are confined to one or more of the pluralit(ies) of the first region of the substrate.

95. The substrate of claim 94, wherein the plurality of the first region and the one or more second region(s) are in a same plane as a top surface of the substrate.

96. The substrate of claim 94, wherein the one or more second region(s) are in a same plane as a top surface of the substrate and the plurality of the first region are disposed in a lower position relative to the one or more second region(s).

97. The substrate of claim 96, wherein the plurality of the first region are wells with a depth of 0 to 3 mm relative to the top surface of the substrate.

98. The substrate of claim 94, wherein the plurality of the first region comprises a hydrophilic, oleophilic, or omniphilic coating.

99. The substrate of claim 94, wherein the plurality of the first region comprises a high surface energy coating.

100. The substrate of claim 94, wherein the one or more second region(s) comprise a hydrophobic, oleophobic, omniphobic, or superomniphobic coating.

101. The substrate of claim 94, wherein the one or more second region(s) comprise a low surface energy coating.

102. The substrate of claim 94, wherein the first contact angle is less than or equal to 90°. 103. The substrate of claim 94, wherein the second contact angle is greater than or equal to 150°. 104. The substrate of claim 94, wherein the plurality of the first region comprises a shape of a circle, rectangle, square, trapezoid, oval, polygon, or any combination thereof.

105. The substrate of claim 94, configured to transfer one or more liquid(s) to a receiving vessel or set of receiving vessels.

106. The substrate of claim 105, wherein the receiving vessel or set of receiving vessels is a second substrate.

107. The substrate of claim 105, wherein the receiving vessel or set of receiving vessels comprises one or more wells.

108. The substrate of claim 105, wherein the substrate is configured to transfer the one or more liquid(s) to the receiving vessel or set of receiving vessels by acceleration or pressure.

109. The substrate of claim 106, wherein the substrate is configured to transfer liquid to the second substrate by direct contact between the one or more liquid(s) on the substrate and one or more liquid(s) on the second substrate.

110. The substrate of claim 106, wherein the substrate is configured to transfer liquid to the second substrate by direct contact between the one or more liquid(s) and the second substrate.

111. The substrate of claim 94, configured to receive one or more liquid(s) from a vessel or set of vessels.

112. The substrate of claim 111, wherein the vessel or set of vessels is a second substrate.

113. The substrate of claim 111, wherein the vessel or set of vessels comprises one or more wells.

114. The substrate of claim 111, wherein the substrate is configured to receive from the vessel or set of vessels by acceleration or pressure.

115. The substrate of claim 112, wherein the substrate is configured to receive liquid from the second substrate by direct contact between one or more liquid(s) on the second substrate and the one or more liquid(s).

116. A method to deposit liquids on a substrate, the method comprising:
positioning the loading device of any of claims 56 through 87 a distance above the substrate of any of claims 88 through 98;
inserting one or more liquid(s) into the loading device; and
traversing the loading device at the distance above the substrate across the substrate in one or more directions.

117. A system, comprising:
a loading device comprising at least one liquid reservoir, the at least one liquid reservoir defining an opening at a bottom portion of the at least one liquid reservoir to discharge a liquid borne by the at least one reservoir;
a substrate holder, at least one of the loading device and/or the substrate holder being movably disposed relative to one another, the substrate holder comprising a substrate receiving area to removably receive a removable substrate, disposed adjacent to the loading device to dispose the substrate receiving area of the substrate holder adjacent the opening at the bottom portion of the at least one liquid reservoir over at least a portion of a range of movement of the loading device relative to the substrate holder; and
one or more registration members provided on the loading device, the substrate holder, or both the loading device and the substrate holder to maintain a spacing between the opening at the bottom portion of the at least one liquid reservoir and an upper surface of a substrate borne within the substrate receiving at a predetermined spacing or within a range of predetermined spacings over at least a portion of a range of movement of the loading device relative to the substrate holder, wherein the predetermined spacing or and/or the range of predetermined spacings are selected to maintain a gap having a first height between a bottom surface of a droplet formed at the opening at the bottom portion of the at least one liquid reservoir and an upper surface of a substrate borne within the substrate over at least a portion of a range of movement of the loading device relative to the substrate holder.

118. The system of claim 117, wherein a height of the at least one liquid reservoir and an area of the opening defined at the bottom portion of the at least one liquid reservoir is dimensioned to form a droplet of a liquid borne by the at least one liquid reservoir having a first contact angle within a predetermined range of contact angles.

119. The system of claim 117, wherein the first height of the gap is less than a capillary length of a liquid borne by the at least one liquid reservoir.

120. The system of claim 117, wherein the loading device comprises a plurality of liquid reservoirs, each of the plurality of liquid reservoirs defining an opening at a bottom portion of the respective liquid reservoir to selectively discharge a liquid borne therein to a substrate borne by the substrate holder.

121. The system of claim 117, further comprising a substrate dimensioned for removable placement within the substrate receiving area, the substrate comprising a first end at a first portion of the range of movement of the loading device relative to the substrate holder and the substrate borne therein and a second end at a second portion of the range of movement of the loading device relative to the substrate holder, the substrate further comprising at least one liquid confinement portion comprising a liquid receiving area in, on, or through the substrate.

122. The system of claim 117, wherein the substrate comprises a plurality of liquid confinement portions.

123. The system of claim 117, wherein the substrate comprises an array of the plurality of liquid confinement portions.

124. The system of claim 123, wherein the array of the plurality of liquid confinement portions comprises a n×m or a n×n array, wherein n or m can be any integer.

125. The system of claim 117, wherein the loading device and the substrate holder are movable relative to one another along one axis.

126. The system of claim 117, wherein the loading device and the substrate holder are translatable relative to one another.

127. The system of claim 117, wherein one of the loading device or the substrate holder is stationary and the other one of the loading device or the substrate holder is translatable relative to the other one of the loading device or the substrate holder.

128. The system of claim 117, wherein one of the loading device or the substrate holder is stationary and the other one of the loading device or the substrate holder is rotatable relative to the other one of the loading device or the substrate holder.

129. The system of claim 117, wherein the loading device and the substrate holder are movable relative to one another along a plurality of axes.

130. The system of claim 117, wherein the plurality of liquid reservoirs are disposed in an array across at least a portion of the loading device.

131. The system of claim 130, wherein the array of the plurality of liquid reservoirs comprises a n×m or a n×n array, wherein n or m can be any integer.

132. The system of claim 117, wherein an upper surface of the substrate outside the liquid receiving areas comprises a hydrophobic, omniphobic, oleophobic, superhydrophobic, superomniphobic, or superoleophobic coating.

133. The system of claim 117, wherein the liquid confinement portion(s) comprise a hydrophilic, oleophilic, or omniphilic coating.

134. The system of claim 117, wherein an upper surface of the substrate comprises a first coating and the liquid confinement portion(s) comprise a second coating different than the first coating.
